(19) United States
(12) Patent Application Publication
(10) Pub. No.: US 2023/0191366 A1
(43) Pub. Date: Jun. 22, 2023

(54) MATERIAL AND METHOD FOR CARBON DIOXIDE FIXATION

(71) Applicant: Kyoto University, Kyoto (JP)

(72) Inventors: Satoshi HORIKE, Kyoto (JP); Kentaro KADOTA, Kyoto (JP)

(21) Appl. No.: 18/076,424

(22) Filed: Dec. 7, 2022

(30) Foreign Application Priority Data
Dec. 9, 2021 (JP) 2021-200011

(51) Int. Cl. B01J 20/22; B01J 20/28; B01J 20/30; C07F 3/06; B01D 53/62; B01D 53/81

(52) U.S. Cl. CPC B01J 20/226; B01D 53/62; B01D 53/81; B01J 20/3085; B01J 20/28059; C07F 3/06; B01D 2253/204; B01D 2257/504

(57) ABSTRACT

[Problem] To provide a new way for fixing carbon dioxide under mild conditions and with high efficiency.

[Solution] The material for carbon dioxide fixation according to the present invention contains a metal ion donor and an amine as a precursor of a bridging ligand. The amine is configured to react with a gaseous carbon dioxide to form the bridging ligand having at least one carbamate anion moiety. The bridging ligand is configured to react with the metal ion donor to form a coordination polymer in which a plurality of the metal ions is linked by the bridging ligand.

### TECHNICAL FIELD

This disclosure relates to a material and method for fixing carbon dioxide. This disclosure also relates to Porous Coordination Polymer (PCP) and the method for manufacturing the same.

### BACKGROUND ART

In recent years, there has been an increasing demand to reduce greenhouse gases in the global environment. One approach that has been studied extensively is to fix carbon dioxide from gases such as air.

A method using an aqueous amine solution is already in practical use for recovering carbon dioxide from gases. The technique of using amines supported on solids has also been studied (Non-Patent Document 1).

On the other hand, a group of materials called Metal-Organic Frameworks (MOFs) is attracting attention in the fields of gas storage and gas separation. Many MOFs are porous and can adsorb carbon dioxide in their pores. Therefore, the use of such MOFs for carbon dioxide fixation and storage is also being considered.

Diamine-appended metal-organic frameworks have recently been reported (Non-Patent Document 2). When carbon dioxide is introduced into this compound, carbon dioxide is chemically inserted between the metal atom and the amine.

### Citation List

### Non-Patent Literature

[Non-Patent Document 1] Christopher W. Jones et al. “Direct Capture of CO₂ from Ambient Air,” Chem. Rev. 2016, 116, 19, 11840-11876
[Non-Patent Document 2] Thomas M. McDonald et al. “Cooperative insertion of CO₂ in diamine-appended metal-organic frameworks,” Nature, 2015, vol. 519, 303-308

### SUMMARY OF THE INVENTION

### Technical Problem

In these circumstances, the present inventors have studied diligently to realize a new concept for fixing carbon dioxide. The purpose of this invention is to provide a new way for fixing carbon dioxide under mild conditions and with high efficiency.

### Solution to Problem

Some aspects of the present invention are as described below.

A material for carbon dioxide fixation, comprising: a metal ion donor; and an amine as a precursor of a bridging ligand, wherein: the amine is configured to react with a gaseous carbon dioxide to form the bridging ligand comprising at least one carbamate anion moiety, and the bridging ligand is configured to react with the metal ion donor to form a coordination polymer in which a plurality of the metal ions is linked by the bridging ligand.

The material according to [1], wherein the amine comprises two or more primary or secondary amine groups, and is configured to react with the gaseous carbon dioxide to form the bridging ligand comprising two or more carbamate anion moieties.

The material according to [1] or [2], wherein the amine is represented by the general formula (1A) below,

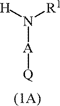

wherein: R¹ is a hydrogen atom or an alkyl group, or forms a heterocycle with A and a nitrogen atom located between R¹ and A, A is a single bond or a linker group comprising at least one carbon atom, andQ is a group configured to form an anion moiety that is able to coordinate to the metal ion.

The material according to [3], wherein R¹ is a hydrogen atom or forms a heterocycle with A and a nitrogen atom located between R¹ and A, the heterocycle having two or less substituent groups other than Q.

The material according to any one of [1] to [4], wherein the amine is represented by the general formula (1A) below,

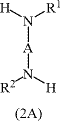

wherein: R¹ is a hydrogen atom or an alkyl group, or forms a heterocycle with A and a nitrogen atom located between R¹ and A, A is a single bond or a linker group comprising at least one carbon atom, and R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.

The material according to [5], wherein R² is a hydrogen atom, or forms a heterocycle with A and a nitrogen atom located between R² and A, having two or less substituent groups other than a group comprising NHR¹, or forms a heterocycle with a nitrogen atom located between R²and A, A, a nitrogen atom located between R¹ and A, and R¹, having two or less substituent groups.

The material according to any one of [1] to [6], wherein the metal ion donor is configured to donate at least one metal ion selecting from the group consisting of a zinc ion, a copper ion, a zirconium ion, a magnesium ion, an iron ion, a cobalt ion, a chromium ion, and an aluminum ion.

The material according to any one of [1] to [7], wherein a content of carbon dioxide in the coordination polymer is 20% by mass or more.

The material according to any one of [1] to [8], wherein the coordination polymer is a porous coordination polymer with a BET (Brunauer-Emmett-Teller) specific surface area calculated from a nitrogen adsorption isotherm at 77 K being 10 m²/g or more, or with an adsorption amount of carbon dioxide at 195 K and 1 atm being 15 cm³(STP)/g or more.

The material according to any one of [1] to [9], wherein a formation of the coordination polymer is configured to be conducted under an atmospheric pressure and normal temperature condition, or under a condition milder than the atmospheric pressure and normal temperature condition.

A method for carbon dioxide fixation, comprising the steps of: preparing a formulation comprising a metal ion donor and an amine configured to react with a gaseous carbon dioxide to form a bridging ligand comprising at least one carbamate anion moiety; and manufacturing a coordination polymer wherein a plurality of the metal ions is linked by the bridging ligand, by supplying the formulation with a gas comprising carbon dioxide.

A method for carbon dioxide fixation, comprising the steps of: forming a bridging ligand comprising at least one carbamate anion moiety by supplying an amine with a gas comprising carbon dioxide; and manufacturing a coordination polymer wherein a plurality of metal ions is linked by the bridging ligand, by reacting the bridging ligand with a metal ion donor.

The method according to [11] or [12], wherein the manufacturing of the coordination polymer is configured to be conducted under an atmospheric pressure and normal temperature condition, or under a condition milder than the atmospheric pressure and normal temperature condition.

The method according to any one of [11] to [13], wherein the gas containing carbon dioxide is air.

A porous coordination polymer, comprising: a plurality of metal ions; and a plurality of bridging ligands, each comprising at least one carbamate anion moiety, wherein: at least a part of the plurality of metal ions is coordinated by the carbamate anion moiety, thereby forming a porous framework wherein the plurality of metal ions and the plurality of bridging ligands are connected to each other, and a BET specific surface area calculated from a nitrogen adsorption isotherm at 77 K is 10 m²/g or more, or with an adsorption amount of carbon dioxide at 195 K and 1 atm is 15 cm³(STP)/g or more.

The porous coordination polymer according to [15], wherein each of the plurality of the bridging ligands has two or more carbamate anion moieties.

The porous coordination polymer according to [15] or [16], wherein each of the plurality of the bridging ligands is represented by the general formula (1B) below,

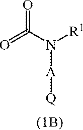

wherein: R¹ is a hydrogen atom or an alkyl group, or forms a heterocycle with A and a nitrogen atom located between R¹ and A, A is a single bond or a linker group comprising at least one carbon atom, and Q⁻ is an anion moiety that is able to coordinate to the metal ion.

The porous coordination polymer according to any one of [15] to [17], wherein each of the plurality of the bridging ligands is represented by the general formula (2B) below,

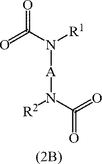

wherein: R¹ is a hydrogen atom or an alkyl group, or forms a heterocycle with A and a nitrogen atom located between R¹ and A, A is a single bond or a linker group comprising at least one carbon atom, and R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.

A method for manufacturing a porous coordination polymer, comprising the steps of: preparing a formulation comprising a metal ion donor and an amine configured to react with a gaseous carbon dioxide to form a bridging ligand comprising at least one carbamate anion moiety; and supplying the formulation with a gas comprising carbon dioxide.

A method for manufacturing a porous coordination polymer, comprising the steps of: forming a bridging ligand comprising at least one carbamate anion moiety by supplying an amine with a gas comprising carbon dioxide; and reacting the bridging ligand with a metal ion donor. Advantageous Effects of Invention

According to the present invention, carbon dioxide can be fixed under mild conditions and with high efficiency.

### BRIEF DESCRIPTION OF DRAWINGS

FIG. 1 shows the PXRD patterns of compounds 1 through 4 and MOF-5.

FIG. 2 shows the PXRD patterns of compounds 1, 1A, 1B, and 1C.

FIG. 3 shows the 1D ¹³C CP-MAS SSNMR spectrum of compound 1.

FIG. 4 shows the 2D ¹H-¹³C HETCOR SSNMR spectrum of compound 1.

FIG. 5 shows the Zn K-edge XANES spectra of compound 1 and Zn-SBU.

FIG. 6 shows the Zn K-edge EXAFS spectrum of compound 1.

FIG. 7 shows the FT-IR spectra of compounds 1 through 4.

FIG. 8 shows the results of the Rietveld analysis of compound 1.

FIG. 9A shows the packing structure of compound 1.

FIG. 9B shows the packing structure of compound 2.

FIG. 9C shows the packing structure of compound 3.

FIG. 9D shows the packing structure of compound 4.

FIG. 10 shows the analysis of the first Bragg peaks of compounds 1 through 4.

FIG. 11 shows the change in PXRD patterns of compounds 1 and 2 in air.

FIG. 12A shows SEM images of compound 1.

FIG. 12B shows SEM images of compound 2.

FIG. 12C shows SEM images of compound 3.

FIG. 12D shows SEM images of compound 4.

FIG. 13 shows the PXRD pattern of compound 2L.

FIG. 14 shows the PXRD pattern of compound 1D.

FIG. 15 shows the TGA profiles of compounds 1 through 4 under argon (Ar) atmosphere.

FIG. 16 shows the nitrogen adsorption isotherms at 77 K for compounds 1 through 4.

FIG. 17 shows the pore size distribution of compounds 1 through 4.

FIG. 18 shows the hydrogen adsorption isotherms at 77 K and the isosteric heat of adsorption curves for the amount of hydrogen adsorbed for compounds 1 through 4.

FIG. 19 shows the carbon dioxide adsorption isotherms at 195 K for compounds 1 through 4.

FIG. 20 shows the high-pressure carbon dioxide adsorption isotherm at 298 K for compound 3.

FIG. 21 shows the nitrogen adsorption isotherms at 77 K for compounds 1, 1A, 1B, and 1C.

FIG. 22 shows the nitrogen adsorption isotherm at 77 K for compound 2L.

FIG. 23 shows the PXRD pattern of compound 5.

FIG. 24 shows the nitrogen adsorption isotherm at 77 K and the carbon dioxide adsorption isotherm at 195 K for compound 5.

FIG. 25 shows the TGA-DTA profile of compound 5.

FIG. 26 shows the solution NMR spectrum of compound 5.

FIG. 27 shows the PXRD patterns of compounds 6 and 6′ and UiO-66.

FIG. 28 shows the nitrogen adsorption isotherms at 77 K for compounds 6 and 6′.

FIG. 29 shows the FT-IR spectra of compounds 6 and 6′, compound 1, and Zr-SBU.

FIG. 30 shows the TGA profiles of compounds 6 and 6′.

FIG. 31 shows the Zr K-edge EXAFS spectra of compound 6′ and Zr-SBU.

FIG. 32 shows the PXRD patterns of compounds 7M, 7E, and 7iP, and Cu-JAST-1.

FIG. 33 shows the carbon dioxide adsorption isotherm at 195 K for compound 7E.

FIG. 34 shows the PXRD pattern of compound 8.

FIG. 35 shows the carbon dioxide adsorption isotherm at 195 K for compound 8.

FIG. 36 shows the TGA profile of compound 8.

FIG. 37 shows the PXRD patterns of compound 9 before and after gas adsorption.

FIG. 38 shows the nitrogen adsorption isotherm at 77 K for compound 9.

FIG. 39 shows the carbon dioxide adsorption isotherm at 195 K for compound 9.

FIG. 40 shows the FT-IR spectra of compound 9 and Zn-SBU.

FIG. 41 shows the TGA-DTA profile of compound 9.

FIG. 42 shows the PXRD pattern of compound 10.

FIG. 43 shows the PXRD patterns of compound 10, a coordination polymer with similar structures, and compound 10P.

FIG. 44 shows the FT-IR spectra of compound 10 and compound 10P.

FIG. 45 shows the nitrogen adsorption isotherm at 77 K and the carbon dioxide adsorption isotherm at 195 K for compound 10.

FIG. 46 shows the PXRD pattern of compound 11.

FIG. 47 shows the nitrogen adsorption isotherm at 77 K for compound 11.

FIG. 48 shows the carbon dioxide adsorption isotherm at 195 K for compound 11.

FIG. 49 shows the TGA-DTA profile of compound 11.

FIG. 50 shows the PXRD patterns of compound 12 and MOF-177.

FIG. 51 shows the FT-IR spectra of compound 12 and compound 1.

FIG. 52 shows the TGA-DTA profile of compound 12.

FIG. 53 shows the PXRD pattern of compound 13.

FIG. 54 shows the PXRD pattern of compound 14.

FIG. 55 shows the carbon dioxide adsorption isotherm at 195 K for compound 14.

FIG. 56 shows the FT-IR spectrum of compound 14.

FIG. 57 shows the TGA-DTA profile of compound 14.

FIG. 58 shows the PXRD pattern of compound 15.

FIG. 59 shows the carbon dioxide adsorption isotherm at 195 K for compound 15.

FIG. 60 shows the TGA-DTA profile of compound 15.

FIG. 61 shows the PXRD pattern of compound 16.

FIG. 62 shows the carbon dioxide adsorption isotherm at 195 K for compound 16.

FIG. 63 shows the TGA-DTA profile of compound 16.

FIG. 64 shows the TGA profiles of compound 2 and PZ-CO₂ in air and under Ar atmosphere.

FIG. 65 shows the TGA and TPD profiles of compound 2 and PZ-CO₂ under Ar atmosphere.

FIG. 66 shows the potential energy as a function of Zn-O distance in the model structures of compound 1 and MOF-5.

FIG. 67 shows the model structure of compound 1 corresponding to the maximum and minimum values of the potential energy.

### DESCRIPTION OF EMBODIMENTS

The following is a description of a material and method for carbon dioxide fixation according to an aspect of the present invention. A porous coordination polymer and its manufacturing method according to an aspect of the present invention will also be described herein. When referring to the drawings, the same reference numerals are given to the components exhibiting the same or similar functions, and duplicate description will be omitted.

First, a material for carbon dioxide fixation according to one aspect of the present invention will be described. The material for carbon dioxide fixation comprises a metal ion donor and an amine as a precursor of a bridging ligand.

The amine is configured to react with a gaseous carbon dioxide to form the bridging ligand having at least one carbamate anion moiety. The bridging ligand is configured to react with the metal ion donor to form a coordination polymer in which a plurality of the metal ions is linked by the bridging ligand.

In other words, in this embodiment, instead of using the already-synthesized coordination polymer (or metal-organic framework) as a material for carbon dioxide fixation, the process of synthesizing a coordination polymer with a specific structure itself is employed for the carbon dioxide fixation, as described in detail below.

There is no restriction on the type of metal ion donor that comprises the material for carbon dioxide fixation, as long as it can form a coordination polymer with the above-mentioned bridging ligands. For example, an appropriate metal ion donor can be selected based on the design principles of the coordination polymers as described below.

The metal elements of the metal ion donor can be, for example, any elements belonging to alkali metals (Group 1), alkaline earth metals (Group 2), or transition metals (Groups 3 to 12). The metal element is selected, for example, from the group consisting of zinc, copper, zirconium, magnesium, calcium, iron, nickel, cobalt, chromium, manganese, and aluminum. The metal element is preferably selected from the group consisting of zinc, copper, zirconium, magnesium, iron, cobalt, chromium, and aluminum. That is, the metal ion donor is configured to donate metal ions selected from the group consisting of, for example, zinc ions, copper ions, zirconium ions, magnesium ions, calcium ions, iron ions, nickel ions, cobalt ions, chromium ions, manganese ions, and aluminum ions. The metal ion donor is preferably configured to donate metal ions selected from the group consisting of zinc ions, copper ions, zirconium ions, magnesium ions, iron ions, cobalt ions, chromium ions, and aluminum ions. The metal ion donor may contain a plurality of metal elements. Alternatively, a plurality of metal ion donors containing different metal elements may be used in combination.

As the metal ion donor, a metal salt is typically used. The metal ion donor may be an organic salt or an inorganic salt. The metal ion donor is typically selected from the group consisting of hydroxides, carbonates, acetates, sulfates, nitrates, and chlorides. A plurality of metal ion donors containing the same metal element may be used in combination.

The metal ion donor may be in the form of a so-called secondary building unit (SBU). Such secondary building units can be chosen from any of those used to synthesize known metal organic frameworks. Examples of typical secondary building units include the iron trimer cluster used in the synthesis of MIL, the zirconium hexamer cluster used in the synthesis of UiO-66, and the zinc tetramer cluster or the cobalt tetramer clusters used in the synthesis of MOF-5.

As mentioned above, the amine comprising the material for carbon dioxide fixation is configured to react with a gaseous carbon dioxide to form the bridging ligand having at least one carbamate anion moiety. The bridging ligand is configured to react with the above-mentioned metal ion donor to form a coordination polymer in which a plurality of the metal ions is linked by the bridging ligand. The formation of the carbamate anion moiety by the above reaction need not occur under any reaction conditions, but only under specific reaction conditions for synthesizing the corresponding coordination polymer. The more thermodynamically stable the bridging ligand and/or the coordinating polymer, the more thermodynamically likely is the fixation of carbon dioxide.

The above amine has at least one primary amine group (amino group) or secondary amine group, and is configured to form a bridging ligand with at least one carbamate anion moiety.

The amine preferably comprises two or more primary or secondary amine groups, and is configured to react with the gaseous carbon dioxide to form the bridging ligand comprising two or more carbamate anion moieties. In this case, for example, a coordination polymer is obtained in which multiple metal ions are linked via these two or more carbamate anion moieties.

If the above amine has only one primary or secondary amine group, the amine must have at least one other coordination site in order to function as a bridging ligand precursor. Examples of such coordination sites other than primary or secondary amine groups include carboxyl group, hydroxyl group, sulfo group, phosphate group, and heterocyclic moiety. Among these, the carboxyl group is particularly preferred. That is, if the above amine has only one primary or secondary amine group, this amine is preferably an amino acid.

The amine is, for example, a compound represented by the following general formula (1A).

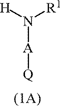

This compound (1A) is configured to react with gaseous carbon dioxide under specific conditions to form a compound represented by the general formula (1B) below, as shown in the scheme below.

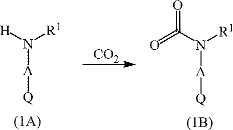

In formulae (1A) and (1B),
R¹ is a hydrogen atom or an alkyl group, or forms a heterocycle with A and a nitrogen atom located between R¹ and A,
A is a single bond or a linker group comprising at least one carbon atom, and
Q is a group configured to form an anion moiety that is able to coordinate to the metal ion, and
Q⁻ is an anionic moiety that is able to coordinate to the metal ion.

This compound (1B) can function as a bridging ligand that bridges multiple metal ions, at least via the carbamate anion moiety shown and the anion moiety formed by Q. That is, this compound (1B) is configured to react with a metal ion donor under specific reaction conditions to form a coordination polymer in which multiple metal ions are linked by compound (1B). The more thermodynamically stable this bridging ligand and/or the coordinating polymer, the more thermodynamically likely is the fixation of carbon dioxide.

In compounds (1A) and (1B), when R¹ is an alkyl group, the alkyl group preferably has 4 or less carbon atoms, and more preferably has 3 or less carbon atoms. Such alkyl groups include methyl, ethyl, n-propyl, i-propyl, n-butyl, i-butyl, s-butyl, and t-butyl group. As such, when R¹ is an alkyl group with a relatively small number of carbon atoms, the steric hindrance around the nitrogen atom of compound (1A) is relatively small, and the nucleophilic reaction of compound (1A) with carbon dioxide by the nitrogen atom is less inhibited. That is, in such cases, compound (1B) is relatively easy to form.

In compounds (1A) and (1B), when R¹ forms a heterocycle with A and a nitrogen atom located between R¹ and A, the heterocycle is, for example, a 5-membered or 6-membered ring, and is preferably a 6-membered ring. Preferred examples of such heterocycles include piperidine and pyrrolidine structures. The heterocycle may contain additional heteroatoms other than the nitrogen atom between R¹ and A. The heterocycle may also comprise substituent groups other than Q. In this case, however, the number of substituent groups other than Q is preferably 2 or less. In such cases, the steric hindrance around the nitrogen atom of compound (1A) is relatively small, and the nucleophilic reaction of compound (1A) with carbon dioxide by the nitrogen atom is less inhibited. That is, in such cases, compound (1B) is relatively easy to form. Also, in such cases, since the compound (1B) as the bridging ligand is less likely to become bulky, the adsorption of the guest molecule to the coordination polymer is hardly inhibited when the coordination polymer to be formed is porous.

If the above heterocycle has substituent groups other than Q, the substituent group is preferably an electron-donating group. In this case, the presence of an electron-donating group improves the nucleophilicity of the nitrogen atom of compound (1A) and can promote the reaction of compound (1A) with carbon dioxide. That is, in such cases, compound (1B) becomes relatively easy to form. Examples of such electron-donating groups include alkyl group, alkoxy group, hydroxyl group, primary amine (amino) group, secondary or tertiary amine group, ester group, and amide group. When the substituent group is an alkyl group, alkoxy group, secondary or tertiary amine group, ester group, or amide group, the number of carbon atoms in the substituent group is preferably 3 or less. In such cases, the steric hindrance around the nitrogen atom of compound (1A) is relatively small, and the nucleophilic reaction of compound (1A) with carbon dioxide by the nitrogen atom is less inhibited. That is, in such cases, compound (1B) is relatively easy to form. Also, in such cases, since the compound (1B) as the bridging ligand is less likely to become bulky, the adsorption of the guest molecule to the coordination polymer is hardly inhibited when the coordination polymer to be formed is porous.

If the above heterocycle has substituent groups other than Q, the substituent group is preferably a hydrophobic group. In this case, the presence of hydrophobic groups can improve the stability of the resulting coordination polymer against water or moisture. That is, in this case, it becomes easier to use the material for carbon dioxide fixation under conditions of high humidity. Examples of such hydrophobic groups include an alkyl group.

Furthermore, if the heterocycle above is provided with a substituent group other than Q, the substituent group may be the one that promotes gas adsorption into the coordination polymer obtained by carbon dioxide fixation. Such substituent groups include, for example, primary amine groups (amino groups), secondary or tertiary amine groups, and perfluoro groups.

In compounds (1A) and (1B), R¹ is preferably a hydrogen atom, an alkyl group having 3 or less carbon atoms, or forms a heterocycle with A and a nitrogen atom located between R¹ and A, in which the number of substituent groups other than Q is 2 or less. More preferably, R¹ is a hydrogen atom or forms a heterocycle with A and a nitrogen atom located between R¹ and A, the heterocycle having two or less substituent groups other than Q. In such cases, as explained earlier, the steric hindrance around the nitrogen atom of compound (1A) is relatively small, and the nucleophilic reaction of compound (1A) with carbon dioxide is less inhibited. That is, in such cases, compound (1B) is relatively easy to form. Also, in such cases, since the compound (1B) as the bridging ligand is less likely to become bulky, the adsorption of the guest molecule is hardly inhibited when the coordination polymer to be formed is porous.

In compounds (1A) and (1B), when A is a linker group comprising at least one carbon atom, the linker group is, for example, a divalent or trivalent linker group, preferably a divalent linker group. Examples of the above linker groups include alkylene group, alkenylene group, and aromatic group. These linker groups may contain ether, ester, and amide bonds in the molecular chain. These linker groups may also have substituent groups as side chains. The above linker groups can be selected as appropriate from the viewpoint of the reactivity between the metal ion donor and the bridging ligand, the physical properties of the resulting coordination polymer, etc.

If A as a linker group has substituent groups as side chains, examples of such substituent groups are the same as those described earlier for substituent groups that heterocycles may have. When A is a linker group containing at least one carbon atom and the linker group has a substituent group as a side chain, the substituent group is preferably bonded to an atom not adjacent to the nitrogen atom between R¹ and A. In this case, the steric hindrance around the nitrogen atom of compound (1A) is relatively small, and the nucleophilic reaction of compound (1A) with carbon dioxide is less inhibited. That is, in such cases, compound (1B) is relatively easy to form.

At least one of the above substituent groups may have the similar properties as Q. That is, at least one of these substituent groups may be a group configured to form an anionic moiety that is able to coordinate to a metal ion. Such anion moiety may be a carbamate anion moiety, the same anion moiety that Q forms, or a different anion moiety than Q forms.

A as a linker group is preferably not conjugated to an adjacent nitrogen atom and is more preferably an alkylene group. When A as the linker group is an alkylene group, the linker group is preferably an C1-C4 alkylene group. That is, A is preferably a methylene group, ethylene group, propylene group, or butylene group, which may have the substituent groups mentioned above. In such cases, the formation of bridging ligands and the reaction of the metal ion donor with the bridging ligand are relatively likely to occur, and the resulting coordination polymer is relatively stable. Examples where A as the linker group is an alkylene group will be discussed in more detail later.

In compounds (1A) and (1B), A is particularly preferred to form a heterocycle with R¹ and the nitrogen atom between R¹ and A, or to be an alkylene group. Examples of preferred heterocycles and alkylene groups are as described earlier.

In compound (1A), Q is a group configured to form an anion moiety that is able to coordinate to the metal ion. In compound (1B), Q⁻ is an anionic moiety that is able to coordinate to the metal ion. Examples of Q include primary amine (amino) group, secondary or tertiary amine group, carboxyl group, hydroxyl group, sulfo group, phosphate group, and heterocyclic moiety. Q is particularly preferred to be a primary or secondary amine group or a carboxyl group. When Q is a primary amine or a secondary amine group, Q may be configured to react with gaseous carbon dioxide to form at least one carbamate anion moiety.

The amine is preferably a compound represented by the following general formula (2A).

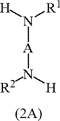

This compound (2A) is configured to react with gaseous carbon dioxide under specific conditions to form a compound represented by the general formula (2B) below, as shown in the scheme below.

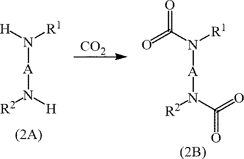

In formulae (2A) and (2B),
R¹ is a hydrogen atom or an alkyl group, or forms a heterocycle with A and a nitrogen atom located between R¹ and A,
A is a single bond or a linker group comprising at least one carbon atom, and
R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.

Compounds (2A) and (2B) correspond to the case where Q is -NHR² in compounds (1A) and (1B), respectively. This compound (2B) can function as a bridging ligand that bridges multiple metal ions at least via two carbamate anion moieties shown. That is, this compound (2B) is configured to react with a metal ion donor under specific reaction conditions to form a coordination polymer in which multiple metal ions are linked by compound (2B). The more thermodynamically stable this bridging ligand and/or the coordinating polymer, the more thermodynamically likely is the fixation of carbon dioxide.

In formulae (2A) and (2B), R¹ and A are the same as described for formulae (1A) and (1B). When A is a linker group containing at least one carbon atom and the linker group has a substituent group as a side chain, the substituent group is preferably bonded to an atom not adjacent to the nitrogen atom between R² and A. In this case, the steric hindrance around the nitrogen atom of compound (2A) is relatively small, and the nucleophilic reaction of compound (2A) with carbon dioxide is less inhibited. That is, in such cases, compound (2B) is relatively easy to form.

In formulae (2A) and (2B), R² typically has the same structure as R¹. In this case, the resulting coordination polymer tends to be highly crystalline because the symmetry of compound (2B) improves.

In formulae (2A) and (2B), when R² is a hydrogen atom or an alkyl group, or forms a heterocycle with A and a nitrogen atom located between R² and A, examples of these alkyl groups and heterocycles are the same as described previously for R¹.

In formulae (2A) and (2B), when R² forms a heterocycle with a nitrogen atom located between R² and A, A, a nitrogen atom located between R¹ and A, and R¹, the heterocycle is, for example, a 5-membered or 6-membered ring, and is preferably a 6-membered ring. Preferred examples of such heterocycles include a piperazine structure. The heterocycle may contain additional heteroatoms other than the two nitrogen atoms. The heterocycle may also comprise substituent groups. In this case, however, the number of substituent groups is preferably 2 or less. In such cases, the steric hindrance around the nitrogen atom of compound (2A) is relatively small, and the nucleophilic reaction of compound (2A) with carbon dioxide by the nitrogen atom is less inhibited. That is, in such cases, compound (2B) is relatively easy to form. Also, in such cases, since the compound (2B) as the bridging ligand is less likely to become bulky, the adsorption of the guest molecule to the coordination polymer is hardly inhibited when the coordination polymer to be formed is porous.

In compounds (2A) and (2B), R² preferably is a hydrogen atom or an alkyl group with 3 or less carbon atoms, or forms a heterocycle with A and a nitrogen atom located between R² and A, having two or less substituent groups other than a group comprising NHR¹, or forms a heterocycle with a nitrogen atom located between R² and A, A, a nitrogen atom located between R¹ and A, and R¹, having two or less substituent groups. R² more preferably is a hydrogen atom, or forms a heterocycle with A and a nitrogen atom located between R² and A, having two or less substituent groups other than a group comprising NHR¹, or forms a heterocycle with a nitrogen atom located between R² and A, A, a nitrogen atom located between R¹ and A, and R¹, having two or less substituent groups. In such cases, as explained earlier, the steric hindrance around the nitrogen atom of compound (2A) is relatively small, and the nucleophilic reaction of compound (2A) with carbon dioxide by the nitrogen atom is less inhibited. That is, in such cases, compound (2B) is relatively easy to form. Also, in such cases, since the compound (2B) as the bridging ligand is less likely to become bulky, the adsorption of the guest molecule to the coordination polymer is hardly inhibited when the coordination polymer to be formed is porous.

As mentioned above, a preferred form of the above amine is the one having a piperidine or piperazine structure. That is, piperidine derivatives, piperazine, or piperazine derivatives can be listed as preferred examples of the above amines.

The amine is, for example, a compound represented by the following general formula (3A).

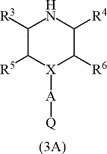

This compound (3A) is configured to react with gaseous carbon dioxide under specific conditions to form a compound represented by the general formula (3B) below, as shown in the scheme below.

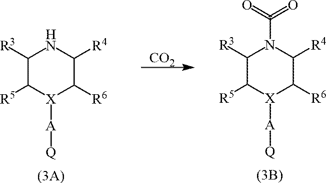

In formulae (3A) and (3B),
X is a carbon or nitrogen atom,
A is a single bond or a linker group comprising at least one carbon atom, and
Q is a group configured to form an anion moiety that is able to coordinate to the metal ion,
Q⁻ is an anionic moiety that is able to coordinate to the metal ion,
Each of R³ to R⁶ is independently a hydrogen atom or any substituent group, and R³ and R⁵ may be bonded to each other to form a ring, and R⁴ and R⁶ may be bonded to each other to form a ring.

In compounds (3A) and (3B), X is a carbon or nitrogen atom. That is, compounds (3A) and (3B) have a six-membered ring containing at least one nitrogen. More specifically, compounds (3a) and (3b) have at least one piperidine or piperazine structure. When such a configuration is employed, a relatively stable coordination polymer can be obtained. That is, when such a configuration is adopted, the fixation of carbon dioxide by the synthesis of the coordination polymer becomes more likely to occur thermodynamically.

In compounds (3A) and (3B), the examples of A and Q are the same as those previously described for compounds (1A) and (1B). As explained earlier, Q may be configured to react with gaseous carbon dioxide to form at least one carbamate anion moiety. In particular, Q may have a piperidine or piperazine structure similar to that shown in formulas (3A) and (3B).

In compounds (3A) and (3B), R³ to R⁶ are each independently a hydrogen atom or any substituent group. Electron-donating groups are preferred as such substituent groups. In this case, the presence of an electron-donating group improves the nucleophilicity of the nitrogen atom of compound (3A) and can promote the reaction of compound (3A) with carbon dioxide. That is, in such cases, compound (3B) becomes relatively easy to form. Examples of such electron-donating groups include alkyl group, alkoxy group, hydroxyl group, primary amine (amino) group, secondary or tertiary amine group, ester group, and amide group. When the substituent group is an alkyl group, alkoxy group, secondary or tertiary amine group, ester group, or amide group, the number of carbon atoms in the substituent group is preferably 3 or less. In such cases, the steric hindrance around the nitrogen atom of compound (3A) is relatively small, and the nucleophilic reaction of compound (3A) with carbon dioxide by the nitrogen atom is less inhibited. That is, in such cases, compound (3B) is relatively easy to form. Also, in such cases, since the compound (3B) as the bridging ligand is less likely to become bulky, the adsorption of the guest molecule to the coordination polymer is hardly inhibited when the coordination polymer to be formed is porous.

In compounds (3A) and (3B), two or more of R³ to R⁶ are preferably hydrogen atoms. That is, preferably, all of R³ to R⁶ are hydrogen atoms, or only one or two of R³ to R⁶ are the substituent groups. In particular, at least one of R³ and R⁴ bonded to the carbon atom adjacent to the nitrogen atom is preferably a hydrogen atom. In such cases, the steric hindrance around the nitrogen atom of compound (3A) is relatively small, and the nucleophilic reaction of compound (3A) with carbon dioxide by the nitrogen atom is less inhibited. That is, in such cases, compound (3B) is relatively easy to form.

When R³ and R⁵ are bonded to each other to form a ring, and/or R⁴ and R⁶ are bonded to each other to form a ring, these rings are, for example, 5-membered or 6-membered rings, and preferably 6-membered rings. When such rings are formed, the number of substituent groups among R³ to R⁶ shall be counted as two per ring.

The amine is, for example, a compound represented by the following general formula (4A).

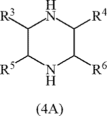

This compound (4A) is configured to react with gaseous carbon dioxide under specific conditions to form a compound represented by the general formula (4B) below, as shown in the scheme below.

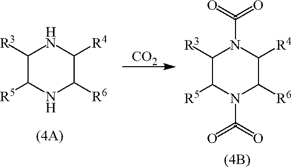

In formulae (4A) and (4B),

Each of R³ to R⁶ is independently a hydrogen atom or any substituent group, and R³ and R⁵ may be bonded to each other to form a ring, and R⁴ and R⁶ may be bonded to each other to form a ring.

As is evident from the chemical formulae, compounds (4A) and (4B) have at least one piperazine structure. That is, compound (4A) is a piperazine or derivative thereof. When such a configuration is employed, an especially stable coordination polymer can be obtained. That is, when such a configuration is adopted, the fixation of carbon dioxide by the synthesis of the coordination polymer becomes more likely to occur thermodynamically.

In compounds (4A) and (4B), the examples of R³ to R⁶ are the same as those previously described for compounds (3A) and (3B). For the same reason as described above, at least one of R⁵ and R⁶ bonded to the carbon atom adjacent to the nitrogen atom is preferably a hydrogen atom.

As explained earlier for compounds (1A) and (2A), in the above amines, the configuration in which A as a linker group is an alkylene group is also preferred. In this case, it is advantageous not only because of the chemical properties of the amines, but also because they are relatively inexpensive to obtain.

The amine is, for example, a compound represented by the following general formula (5A).

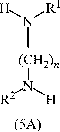

This compound (5A) is configured to react with gaseous carbon dioxide under specific conditions to form a compound represented by the general formula (5B) below, as shown in the scheme below.

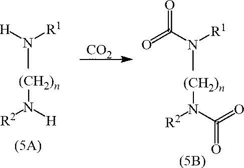

In formulae (5A) and (5B),
R¹ is a hydrogen atom or an alkyl group,
R² is a hydrogen atom or an alkyl group, and
n is 0 or a natural number.

In compounds (5A) and (5B), the examples of R¹ and R² are the same as those previously described for compounds (2A) and (2B). Both R¹ and R² are preferably hydrogen atoms.

In compounds (5A) and (5B), n is 0 or a natural number, preferably a natural number, more preferably a natural number from 1 to 4. That is, compound (5A) preferably comprises an alkylene group, and more preferably comprises a methylene group, an ethylene group, a propylene group, or a butylene group.

Specific examples of the above amines include the following compounds. These are examples only and do not preclude the use of other compounds.

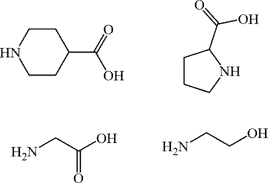

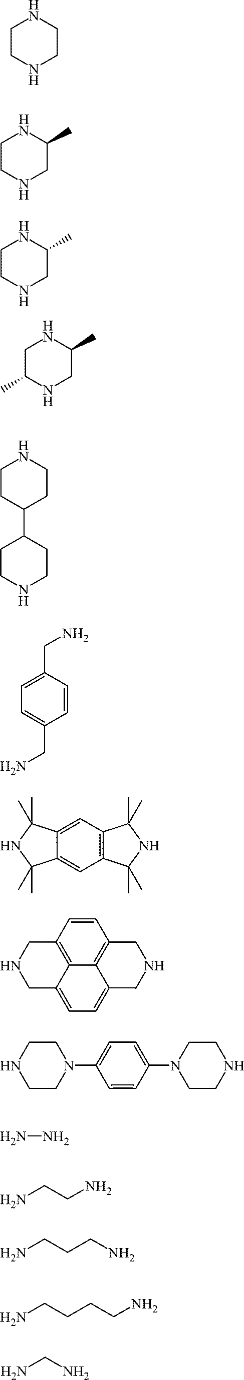

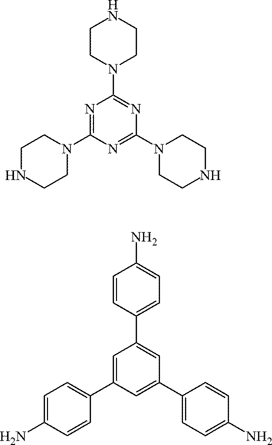 [SMILES: C1CN(c2nc(N3CCNCC3)nc(N3CCNCC3)n2)CCN1 ; Nc1ccc(-c2cc(-c3ccc(N)cc3)cc(-c3ccc(N)cc3)c2)cc1]

The material for carbon dioxide fixation may contain multiple kinds of amines. In that case, at least one of the amines needs to be configured to react with gaseous carbon dioxide to form a bridging ligand with at least one carbamate anion moiety. That is, the material for carbon dioxide fixation may contain two or more kinds of amines as bridging ligand precursors, or may further contain amines that do not function as the bridging ligand precursors.

Here, as described above, in the material for carbon dioxide fixation according to one aspect of the present invention, the synthesis process of the coordination polymer using the carbamate anion is employed. The above-mentioned combination of the metal ion donor and the amine as the bridged ligand precursor is arbitrary as long as the following conditions are satisfied.

(Condition 1) The amine is configured to react with gaseous carbon dioxide to form a bridging ligand having at least one carbamate anion moiety (hereinafter referred to as a carbamate ligand).

(Condition 2) The above carbamate ligand is configured to react with a metal ion donor to form a coordination polymer in which multiple metal ions are linked by the bridging ligand.

Various combinations of metal ion donors and amines that satisfy these conditions can be considered, and all of which are within the scope of the present invention. When selecting specific combinations, for example, the following design principles may be adopted.

In this exemplary design principle, an existing metal organic framework is first selected as the motif. Next, an amine that is structurally similar to the ligand used to synthesize the known metal organic framework is designed. The same synthesis is then carried out in the presence of amine and carbon dioxide to synthesize coordination polymers with similar structures. Specific examples include the combinations shown in Table 1 below.

TABLE 1

| | | | |
|---|---|---|---|
| Known MOF | Metal | Main Ligand | Examples of Carbamate Ligand with Similar Structure |
| UIO-66 | Zr | 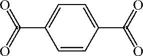 | 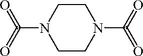 |
| MIL-53(Fe) | Fe | | |
| MIL-53(Al) | Al | | |
| MOF-5 | Zn | | |
| Cu-JAST | Cu | | |
| UIO-67 | Zr | 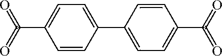 | 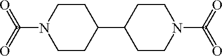 |
| MOF-801 | Zr | 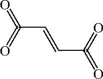 | 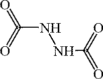 |
| AlFDC | Al | | |
| MOF-177 | Zn | 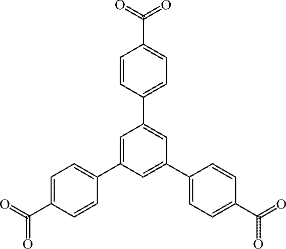 | 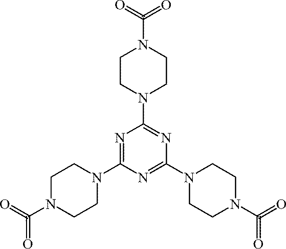 |

The combinations shown in Table 1 above are examples only, and other existing metal organic frameworks may be used as motifs. In addition, the amine or carbamate ligands of similar structures in the above design principles can be modified with substituent groups as appropriate from the viewpoint of controlling reactivity, etc. Furthermore, the above design principle is just an example, and it is of course possible to combine metal ion donors and amines in which motifs of existing metal organic frameworks do not exist.

As described above, the material for carbon dioxide fixation according to the present embodiment utilizes the synthesis of a coordination polymer by the reaction of a metal ion donor with a carbamate ligand. The advantages of using carbamate ligands in the fixation of carbon dioxide using the synthesis of such coordination polymers are described below.

First of all, it is extremely difficult to use carbon dioxide itself as a bridging ligand of a coordination polymer because of its reactivity and molecular size. Therefore, when carbon dioxide is to be fixed using the synthesis of coordination polymers, one possible strategy is to embed carbon dioxide into the bridging ligand.

As suggested by Table 1 above, dicarboxylate or tricarboxylate ligands have been commonly used as bridging ligands in coordination polymers. However, the synthesis of such carboxylate ligands from carbon dioxide requires high-energy reagents, catalysts, and/or stringent reaction conditions in multistep reactions. Therefore, the use of the formation of carboxylate ligands from carbon dioxide in the fixation of carbon dioxide by the synthesis of coordination polymers is not practical from the viewpoint of energy efficiency, etc.

Another possible method is to form carbonate ions (CO₃²⁻) and formate ions (HCO₂₋) from carbon dioxide to form coordination polymers, but there are many limitations in terms of stability and diversity of the resulting coordination polymers. It is also difficult to obtain porous coordination polymers as described below due to the small molecular size of the carbonate and formate ions.

In contrast to these, the use of carbamate ligands in the fixation of carbon dioxide using the synthesis of coordination polymers has several advantages.

Usually, carbamate anions are thermodynamically unstable and are prone to react back to amines by carbon dioxide separation. However, the inventors have found that carbamate structures can be stably incorporated into coordination polymers by coordinating carbamate anions to metal ions (see Examples for details). Such a mechanism can thermodynamically promote the formation of bridging ligands by the reaction of amines with carbon dioxide and the formation of coordination polymers by the reaction of metal ion donors with bridging ligands in the material for carbon dioxide fixation according to the present embodiment. Therefore, these reactions have been found to make it possible to fix carbon dioxide under milder conditions and with higher efficiency.

In addition, carbamate ligands and amines as their precursors can have a wide variety of structures. Therefore, the optimal combination of metal ion donor and amine can be designed by adjusting the combination of metal ion donor and amine according to the required application. Similarly, it is also possible to control the physical properties of the resulting coordination polymers by changing the above combinations.

The material for carbon dioxide fixation according to the present embodiment may further contain other components in addition to the metal ion donor and the amine.

For example, the material for carbon dioxide fixation may further contain ligands or precursors thereof other than amines and the carbamate ligands obtained therefrom. Such auxiliary ligands may be bridging ligands or unidentate ligands.

The material for carbon dioxide fixation may further contain a solvent if necessary. As such a solvent, for example, a first solvent for dissolving a metal ion donor and a second solvent for dissolving an amine can be used in combination. The first and second solvents may be identical or different from each other. As such solvents, it is preferable to use liquids that can easily dissolve gaseous carbon dioxide.

Any solvents can be used. The solvent can be, for example, an alcohol, a non-protic solvent, or water. Alcohols or non-protic solvents are preferred. Alcohols include, for example, methanol, ethanol, and isopropanol. Non-protic solvents include, for example, amides such as N,N-dimethylformamide (DMF), nitriles such as acetonitrile, and ethers such as tetrahydrofuran (THF). These solvents may be dehydrated. A mixture of a plurality of solvents may also be used.

The material for carbon dioxide fixation may further contain additional substances such as reaction accelerators. Reaction accelerators are, for example, basic substances. It is preferable to use such a basic substance that is unlikely to undergo a nucleophilic reaction to carbon dioxide. That is, it is preferable to use a non-nucleophilic base as the basic material. Examples of such non-nucleophilic bases include diazabicycloundecene (DBU), 1,1,3,3-tetramethylguanidine (TMG), N,N-diisopropylethylamine (DIPEA), 2,6-lutidine, pyridine, and imidazole. As an additional substance, a reaction control agent may also be added. Ammonium acetate or sodium acetate can be used as a reaction control agent, for example, in terms of controlling complexation. Catalysts may also be added as needed.

As described above, the use of the material for carbon dioxide fixation according to the present embodiment makes it possible to fix carbon dioxide under mild conditions with high efficiency. For example, the formation of coordination polymers with fixation of carbon dioxide according to the present embodiment can take place under atmospheric pressure and normal temperature conditions, or under a condition milder than the atmospheric pressure and normal temperature condition. That is, the formation of coordination polymers with fixation of carbon dioxide according to the present embodiment can take place under ambient conditions, or a condition milder than the ambient condition. In such cases, carbon dioxide fixation can be performed under more environmentally friendly conditions. The term “ambient conditions” here refers to conditions in which no additional heating or pressurization is applied, specifically, normal temperature (ambient temperature) and normal pressure (atmospheric pressure) in the environment in which the material for carbon dioxide fixation is used. The terms “a condition milder than the atmospheric pressure and ambient temperature condition” and “a condition milder than the ambient condition” refer to conditions of lower temperature than normal temperature, and lower pressure than normal pressure.

As mentioned above, the use of the material for carbon dioxide fixation according to the present embodiment produces coordination polymers. In other words, the material for carbon dioxide fixation after use yields coordination polymers. This coordination polymer may have the following properties, for example.

The coordination polymer in which carbon dioxide is fixed may have a carbon dioxide content in its structure that is preferably 20 mass% or more, more preferably 25 mass% or more, and particularly preferably 30 mass% or more. The higher the carbon dioxide content in the coordination polymer, the more efficient the fixation of carbon dioxide by the material for carbon dioxide fixation can be. The “carbon dioxide content” here is a theoretical value calculated from the composition formula of the coordination polymer.

The above coordination polymers may be crystalline or amorphous. The above coordination polymers are preferably crystalline. If the above coordination polymers are crystalline, it is suggested that the carbamate ligands are regularly incorporated into the coordination polymer framework. Such a structure is thermodynamically favorable, so the crystalline nature of the resulting coordination polymer means that carbon dioxide fixation using the material for carbon dioxide fixation according to the present embodiment is more likely to occur. Here, the fact that the coordination polymer is “crystalline” means that a sharp or broad peak is observed around 20=10° in powder X-ray diffraction (PXRD) measurements using a CuKa anode, and the fact that the coordination polymer is “amorphous” means that no such peak is observed.

If the above coordination polymer is crystalline, this coordination polymer preferably has high crystallinity. Here, the fact that the coordination polymer has “high crystallinity” means that the half width of the strongest peak at around 2θ=10° is 3 degrees or less in PXRD measurements using a CuKa anode.

As described earlier, the above coordination polymers may be porous. Here, the fact that the coordination polymer is “porous” means that a BET specific surface area calculated from a nitrogen adsorption isotherm at 77 K is 10 m²/g or more, or an adsorption amount of carbon dioxide at 195 K and 1 atm is 15 cm³(STP)/g or more. If the coordination polymer is porous, the resulting coordination polymer itself can be further used for gas storage or other purposes. In particular, the resulting coordination polymer itself can be used further as a material for carbon dioxide fixation. The properties of such porous coordination polymers will be discussed in more detail later.

If the obtained coordination polymer itself can also be used as a material for carbon dioxide fixation, the maximum adsorption amount of carbon dioxide by the coordination polymer is preferably 20 mass% or more, more preferably 25 mass% or more, and particularly preferably 30 mass% or more. In this case, the sum of the carbon dioxide content and the maximum adsorption amount is preferably 40 mass% or more, more preferably 50 mass% or more, and particularly preferably 60 mass% or more. In such cases, the products obtained by carbon dioxide fixation can be used for further carbon dioxide fixation, thereby further improving the effective fixation efficiency of carbon dioxide. The “maximum adsorption amount of carbon dioxide” here is a value obtained by conducting carbon dioxide adsorption experiments at 298 K under high pressure, and corresponds to the amount of carbon dioxide adsorbed when the pores of the porous coordination polymer are almost completely filled with carbon dioxide.

As mentioned above, the amine comprising the material for carbon dioxide fixation according to the present embodiment is configured to react with a gaseous carbon dioxide to form the bridging ligand having at least one carbamate anion moiety. The bridging ligand is configured to react with the metal ion donor to form a coordination polymer in which a plurality of the metal ions is linked by the bridging ligand. However, the formation of the bridging ligand and the formation of the coordination polymer do not necessarily have to occur in separate steps. For example, the formation of the carbamate anion moiety and its coordination to the metal ion may occur simultaneously. It may also utilize a reaction mechanism such that carbon dioxide activated by metal ions reacts with amines to produce carbamate anion moieties.

In the material for carbon dioxide fixation according to the present embodiment, the metal ion donor and the amine may react to form a precursor of the coordination polymer. In this case, for example, the metal ion and the amine may pre-form a metal complex. The metal complex may then be configured to react with gaseous carbon dioxide to form the above coordination polymer in which the metal ion is bridged by a bridging ligand having at least one carbamate anion moiety. The metal complex as a precursor of the coordination polymer described above may itself be another coordination polymer. However, it is more preferable to have a configuration in which a largely linked coordination polymer is formed only when a carbamate anion moiety is created by the introduction of carbon dioxide, without having a pre-linked structure. That is, in a configuration in which metal ions and amines form metal complexes beforehand, it is more preferable that the metal complex as a precursor of the coordination polymer is not a coordination polymer.

Next, the method of fixing carbon dioxide in accordance with an aspect of the present invention will be described. The method for carbon dioxide fixation typically utilizes the material for carbon dioxide fixation described above. However, the metal ion donors and amines that comprise the material for carbon dioxide fixation material do not necessarily have to be present at the same time. For example, in this method of fixing carbon dioxide, the metal ion donor and amine may be introduced sequentially.

The first example of a method for carbon dioxide fixation method according to the present embodiment comprises the steps of: preparing a formulation comprising a metal ion donor and an amine configured to react with a gaseous carbon dioxide to form a bridging ligand comprising at least one carbamate anion moiety; and manufacturing a coordination polymer wherein a plurality of the metal ions is linked by the bridging ligand, by supplying the formulation with a gas comprising carbon dioxide. As is evident from the second step, the method of fixing carbon dioxide according to the present embodiment is substantially equivalent to the method of manufacturing coordination polymers. That is, the method of fixing carbon dioxide according to the first example is also a method of manufacturing a coordination polymer comprising the steps of: preparing a formulation comprising a metal ion donor and an amine configured to react with a gaseous carbon dioxide to form a bridging ligand comprising at least one carbamate anion moiety; and supplying the formulation with a gas comprising carbon dioxide.

As described above, this first example involves supplying a gas containing carbon dioxide to the above-described material for carbon dioxide fixation. This allows for the fixation of carbon dioxide using the synthetic process of coordination polymers, as explained earlier. As mentioned above, in this case, the above formulation may pre-form a metal complex as a precursor to a coordination polymer.

The second example of a method for carbon dioxide fixation method according to the present embodiment comprises the steps of: forming a bridging ligand comprising at least one carbamate anion moiety by supplying an amine with a gas comprising carbon dioxide; and manufacturing a coordination polymer wherein a plurality of metal ions is linked by the bridging ligand, by reacting the bridging ligand with a metal ion donor. Similar to the first example above, the method of fixing carbon dioxide according to the second example is also a method of manufacturing a coordination polymer comprising the steps of: forming a bridging ligand comprising at least one carbamate anion moiety by supplying an amine with a gas comprising carbon dioxide; and reacting the bridging ligand with a metal ion donor.

As described above, in this second example, the process of forming a bridging ligand by the reaction of amine with carbon dioxide and the process of reacting the obtained bridging ligand with a metal ion donor to produce a coordination polymer are arranged in separate steps. This method also allows for the fixation of carbon dioxide using the synthetic process of coordination polymers as described earlier.

Examples of metal ion donors and amines used in each of the above examples can be the same as those previously described for the material for carbon dioxide fixation.

The gas containing carbon dioxide used in each of the above examples is, for example, air, preferably dry air. Alternatively, the gas may be the one containing carbon dioxide derived from a specific point source. The above gas may be a gas essentially consisting of carbon dioxide.

As mentioned above, the above methods of carbon dioxide fixation allow carbon dioxide to be fixed under mild conditions and with high efficiency. In particular, this method of fixing carbon dioxide is preferably performed under ambient conditions or the conditions milder than the ambient conditions.

Fixation of carbon dioxide by the above methods is typically performed in a solvent. Additional substances such as reaction accelerators can also be further used in each step of the above methods. Examples of these solvents and additional substances are similar to those previously described in relation to the material for carbon dioxide fixation.

The porous coordination polymer according to one aspect of the present invention will be described below. The porous coordination polymer is typically obtained by fixing carbon dioxide by the method described above. The resulting porous coordination polymers can have excellent properties in themselves. The porous coordination polymer may be synthesized by a method that does not involve the carbon dioxide fixation.

The porous coordination polymer according to one aspect of the present invention contains a plurality of metal ions and a plurality of bridging ligands each having at least one carbamate anion moiety. At least a part of the plurality of metal ions is coordinated by the carbamate anion moiety, thereby forming a porous framework wherein the plurality of metal ions and the plurality of bridging ligands are connected to each other. As will be explained later, the porous coordination polymer has a BET (Brunauer-Emmett-Teller) specific surface area calculated from a nitrogen adsorption isotherm at 77 K being 10 m²/g or more, or having an adsorption amount of carbon dioxide at 195 K and 1 atm being 15 cm³(STP)/g or more.

The metal ions comprising the above porous coordination polymers are, for example, the same as those described earlier as metal ions that can be donated by metal ion donors.

Similar ones as described above can be used for a plurality of bridging ligands with at least one carbamate anion moiety. The bridging ligand preferably has two or more carbamate anion moieties.

As mentioned above, the carbamate structure is thermodynamically unstable by nature, but by coordinating the carbamate anion with the metal ion, the carbamate structure can be stably incorporated into the coordinating polymer. This stabilization is particularly pronounced when metal ions and bridging ligands are linked together to form a porous framework.

The above bridging ligand is, for example, a compound represented by the following general formula (1B):

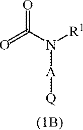

In formula (1B),
R¹ is a hydrogen atom or an alkyl group, or forms a heterocycle with A and a nitrogen atom located between R¹ and A,
A is a single bond or a linker group comprising at least one carbon atom, and
Q⁻ is an anionic moiety that is able to coordinate to the metal ion.

Preferred examples of R¹, A, and Q⁻ in compound (1B) are the same as described previously. The more thermodynamically likely the fixation of carbon dioxide described earlier is to occur, the more thermodynamically stable the porous coordination polymer containing compound (1B) as a bridging ligand is likely to be.

The above bridging ligand may be a compound represented by the following general formula (2B):

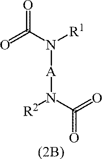

In formula (2B),
R¹ is a hydrogen atom or an alkyl group, or forms a heterocycle with A and a nitrogen atom located between R¹ and A,
A is a single bond or a linker group comprising at least one carbon atom, and
R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.

Preferred examples of R¹, A, and R² in compound (2B) are the same as described previously. The more thermodynamically likely the fixation of carbon dioxide described earlier is to occur, the more thermodynamically stable the porous coordination polymer containing compound (2B) as a bridging ligand is likely to be.

The above bridging ligand may be a compound represented by the following general formula (3B):

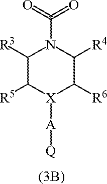

In formula (3B),
X is a carbon or nitrogen atom,
A is a single bond or a linker group comprising at least one carbon atom, and
Q⁻ is an anionic moiety that is able to coordinate to the metal ion,
Each of R³ to R⁶ is independently a hydrogen atom or any substituent group, and R³ and R⁵ may be bonded to each other to form a ring, and R⁴ and R⁶ may be bonded to each other to form a ring.

Preferred examples of X, A, Q⁻, and R³ to R⁶ in compound (3B) are the same as described previously. The more thermodynamically likely the fixation of carbon dioxide described earlier is to occur, the more thermodynamically stable the porous coordination polymer containing compound (3B) as a bridging ligand is likely to be.

The above bridging ligand may be a compound represented by the following general formula (4B):

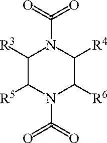

In formula (4B),

Each of R³ to R⁶ is independently a hydrogen atom or any substituent group, and R³ and R⁵ may be bonded to each other to form a ring, and R⁴ and R⁶ may be bonded to each other to form a ring.

Preferred examples of R³ to R⁶ in compound (4B) are the same as described previously. The more thermodynamically likely the fixation of carbon dioxide described earlier is to occur, the more thermodynamically stable the porous coordination polymer containing compound (4B) as a bridging ligand is likely to be.

The above bridging ligand may be a compound represented by the following general formula (5B):

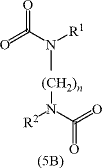

In formula (5B),
R¹ is a hydrogen atom or an alkyl group,
R² is a hydrogen atom or an alkyl group, and
n is 0 or a natural number.

Preferred examples of R¹, R², and n in compound (5B) are the same as described previously. The more thermodynamically likely the fixation of carbon dioxide described earlier is to occur, the more thermodynamically stable the porous coordination polymer containing compound (5B) as a bridging ligand is likely to be.

As mentioned above, in porous coordination polymers according to the present embodiment, metal ions and bridging ligands with at least one carbamate anion moiety are linked together to form a porous framework. The thermodynamic stability of the carbamate anion moiety can be improved by introducing the carbamate anion moiety into the porous framework.

The porous coordination polymer according to the present embodiment has a BET specific surface area calculated from the nitrogen adsorption isotherm at 77 K of 10 m²/g or more, preferably 15 m²/g or more, more preferably 50 m²/g or more, furthermore preferably100m²/g or more, and even more preferably 500 m²/g or more. The larger the BET specific surface area, the better the porosity of the coordination polymer.

The porous coordination polymer according to the present embodiment has an adsorption amount of carbon dioxide at 195 K and 1 atm of preferably 15 cm³(STP)/g or more, more preferably 20 cm³(STP)/g or more, furthermore preferably 40 cm³(STP)/g or more, and even more preferably 100 cm³(STP)/g or more. The larger the adsorption amount of carbon dioxide, the better the porosity of the coordination polymer.

Porous coordination polymers according to the present embodiment can be utilized, for example, for gas adsorption and storage. The porous coordination polymers may also be applied as functional materials such as catalysts by utilizing the metal ion and/or carbamate structures in their framework. As mentioned above, the porous coordination polymer can also be used by itself as a material for carbon dioxide fixation.

The following is a description of a method for manufacturing porous coordination polymers in accordance with an aspect of the present invention. The method of producing porous coordination polymers according to the present embodiment utilizes the carbon dioxide fixation process described earlier.

A first example of a method of producing a porous coordination polymer according to this aspect includes the steps of: preparing a formulation comprising a metal ion donor and an amine configured to react with a gaseous carbon dioxide to form a bridging ligand comprising at least one carbamate anion moiety; and supplying the formulation with a gas comprising carbon dioxide.

The second example of a method of producing a porous coordination polymer according to this aspect includes the steps of: forming a bridging ligand comprising at least one carbamate anion moiety by supplying an amine with a gas comprising carbon dioxide; and reacting the bridging ligand with a metal ion donor.

As the metal ion donors, amines, bridging ligands, and the gas containing carbon dioxide in these production methods, for example, the same as those described above for the carbon dioxide fixation method can be used. These production methods are typically performed in solvents. Additional substances such as reaction accelerators can also be further used in each step of the above methods. Examples of these solvents and additional substances are similar to those previously described in relation to the material and method for carbon dioxide fixation.

### EXAMPLES

The above material and method for carbon dioxide fixation, as well as the porous coordination polymer and its production method, will be further described below with reference to examples.

### Fixation of Carbon Dioxide by Synthesis of Coordination Polymers

Initially, the specific method of carbon dioxide fixation accompanied by the synthesis of coordination polymers is described. The reagents used were purchased from Sigma-Aldrich (Merck & Co.), Tokyo Kasei Kogyo, Wako Pure Chemical Industries, Ltd. or Nakalay Tesque Co. The abbreviations used below are also shown in Table 2 below.

TABLE 2-1

| | |
|---|---|
| Abbreviation | Structure |
| PZ | 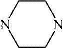 |
| PDC | 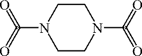 |
| BDC | 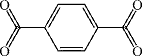 |
| SmPZ | 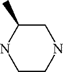 |
| S-mPDC | 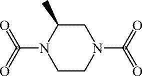 |
| RmPZ | 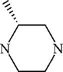 |
| R-mPDC | 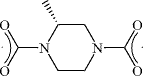 |
| dmPZ | 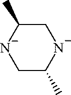 |
| dmPDC | 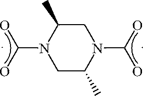 |

TABLE 2-2

| | |
|---|---|
| Zn-SBU | 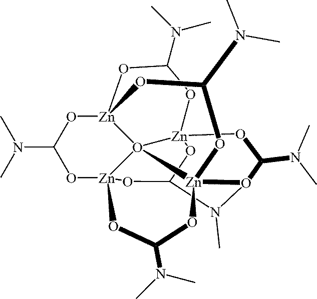 |
| PZ-CO₂ | 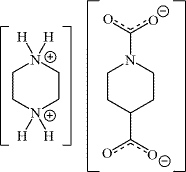 |
| PZ-CO₂-DBU | 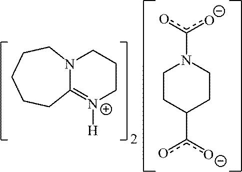 |
| bpy | 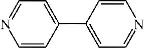 [SMILES: c1cc(-c2ccncc2)ccn1] |
| dabco | 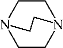 |

TABLE 2-3

| | |
|---|---|
| Zr-SBU | 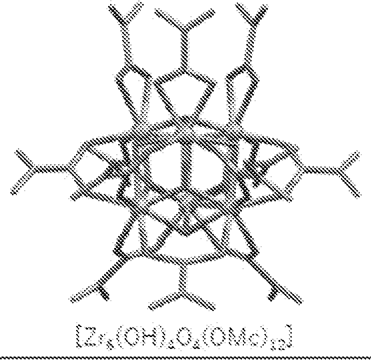 |
| eda | 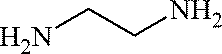 |
| pda | 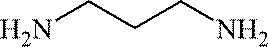 |
| HZ | 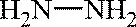 [SMILES: C1CC(C2CCNCC2)CCN1] |
| DP | 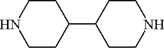 |
| pXDA | 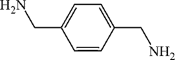 [SMILES: C1CN(c2nc(N3CCNCC3)nc(N3CCNCC3)n2)CCN1] |
| tpt | 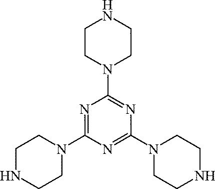 |

### Example 1

### Method 1

A 100 mL of DMF solution of Zn(OAc)₂·2H₂O (878.0 mg, 4.00 mmol) was mixed with a 100 mL iPrOH solution of H₂PZ (258.4 mg, 3.00 mmol) and DBU (1.795 mL, 12.0 mmol) in a 300 mL round bottom flask at 25° C. inside an Ar-filled glovebox. The resultant transparent solution was stirred for 3 min. The flask was sealed with a rubber septum and taken outside the glovebox. Thus, the material for carbon dioxide fixation for Example 1 was obtained.

Next, CO₂ gas (>99.99%) was flowed into the round bottom flask at 25° C. The white precipitate was formed immediately (< 10 sec). The reaction mixture was stirred under CO₂ flowing overnight to complete the reaction. In visual observation, this reaction was almost complete within a few hours. In this way, carbon dioxide fixation was performed using the material for carbon dioxide fixation according to Example 1.

The flask was purged with Ar and taken inside the glovebox. The precipitate was collected by filtration and washed with DMF and iPrOH under Ar, and dried under vacuum at 25° C. Thus, the coordination polymer [Zn₄O(PDC)₃] was obtained (80% yield, Calcd for C₁₈H₂₄N₆O₁₃Zn₄: C, 27.23; H, 3.05; N, 10.59. Found: C, 27.20; H, 4.17; N, 10.19.). Hereafter, this coordination polymer will be referred to as “Compound 1”.

### Method 1A

First, Zn-SBU was synthesized as a metal ion donor. This synthesis was performed according to the following literatures.

Reference 1: Dell’Amico, D.B. et al. Inorg. Chem. Acta 2003, 350, 661-664

Reference 2: Dell’Amico, D.B. et al. Inorg. Chem. Acta 2006, 359 (10), 3371-3374

The synthetic scheme of Zn-SBU is shown below. It should be noted that, in the scheme below, the NCO₂ moiety in Zn-SBU is derived from the raw material, that is, dimethylammonium dimethylcarbamate (Sigma-Aldrich; Merck & Co.), and is not derived from the gaseous CO₂.

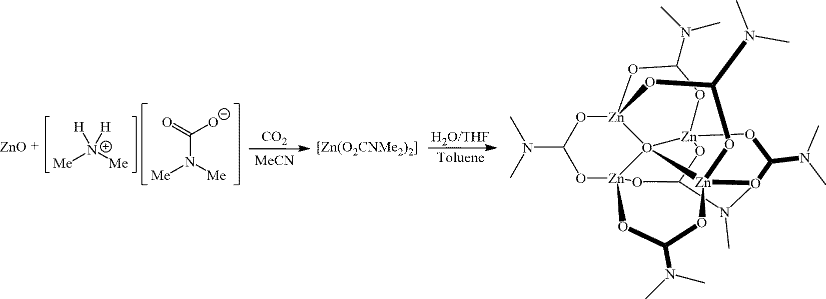

Next, PZ-CO₂-DBU was synthesized as a source of the bridging ligand. To a MeCN solution (20 mL) of H2PZ (344.6 mg, 4.00 mmol) in a 50 mL round bottom flask, DBU (1.196 mL, 8.00 mmol) was added dropwise inside an Ar-filled glovebox. The flask was sealed with a rubber septum and taken outside the glovebox. CO₂ gas (>99.99%) was flowed into the round bottom flask at 25° C. At this stage, colorless crystals precipitated immediately. After 12 hours, the reaction was completed. In visual observation, this reaction was almost complete in about 30 minutes to 1 hour. The flask was purged with Ar and taken inside the glovebox. The crystals were collected by filtration and washed with anhydrous MeCN under Ar, and dried under vacuum at 25° C. (82% yield) The synthetic scheme of PZ-CO₂-DBU is shown below.

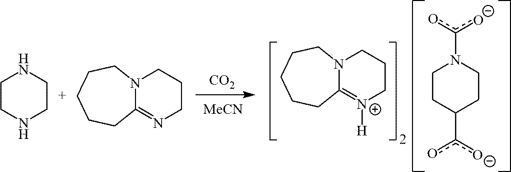

A 10 mL of iPrOH solution of PZ-CO2-DBU (168.2 mg, 0.30 mmol) was added into a 10 mL of THF solution of Zn-SBU (90.4 mg, 0.10 mmol) under Ar at 25° C. A white precipitate was formed immediately and kept at 25° C. overnight. In visual observation, this reaction was almost complete in about 30 minutes to 1 hour. The obtained precipitate was collected by filtration, and washed with iPrOH and THF under Ar, and dried under vacuum at 25° C. Thus, the coordination polymer [Zn₄O(PDC)₃] was obtained (94% yield). Hereafter, this coordination polymer will be referred to as “Compound 1A”.

### Method 1B

A 10 mL of iPrOH solution of PZ-CO₂-DBU (336.4 mg, 0.30 mmol) was added into a 10 mL of DMF solution of Zn(OAc)₂·2H₂O (65.9 mg, 0.30 mmol) under Ar at 25° C. A white precipitate was formed immediately and kept at 25° C. overnight. In visual observation, this reaction was almost complete in about 30 minutes to 1 hour. The obtained precipitate was collected by filtration, and washed with DMF and iPrOH under Ar, and dried under vacuum at 25° C. Thus, the coordination polymer [Zn₄O(PDC)₃] was obtained (85% yield). Hereafter, this coordination polymer will be referred to as “Compound 1B”.

### Method 1C

Carbon dioxide fixation was performed as in Method 1, except that DBU was not used. The reaction time by visual observation was almost the same as in Method 1. Thus, the coordination polymer [Zn₄O(PDC)₃] was obtained (80% yield). Hereafter, this coordination polymer will be referred to as “Compound 1C”.

### Method 1D

The procedure of 1-from-air was followed by that of Method 1 using compressed air gas (>99.99%) containing 400 ppm of CO₂ instead of pure CO₂, and reaction time was extended from overnight to 6 days. In visual observation, this reaction was almost complete in about 24 hours. Thus, the coordination polymer [Zn₄O(PDC)₃] was obtained (61% yield). Hereafter, this coordination polymer will be referred to as “Compound 1D”.

### Example 2

### Method 2

A 30 mL of DMF solution of Zn(OAc)₂·2H₂O (263.4 mg, 1.20 mmol) was mixed with a 30 mL iPrOH solution of H₂[SmPZ] (90.2 mg, 0.90 mmol) and DBU (540 µL, 3.60 mmol) in a 100 mL round bottom flask at 25° C. inside an Ar-filled glovebox. The resultant transparent solution was stirred for 3 min. The flask was sealed with a rubber septum and taken outside the glovebox. Thus, the material for carbon dioxide fixation for Example 2 was obtained.

Next, CO₂ gas (>99.99%) was flowed into the round bottom flask at 25° C. The white precipitate was formed immediately (< 10 sec). The reaction mixture was stirred under CO₂ flowing overnight to complete the reaction. In visual observation, this reaction was almost complete in about 30 minutes to 1 hour. In this way, carbon dioxide fixation was performed using the material for carbon dioxide fixation according to Example 2.

The flask was purged with Ar and taken inside the glovebox. The precipitate was collected by filtration and washed with DMF and iPrOH under Ar, and dried under vacuum at 25° C. Thus, the coordination polymer [Zn₄O(S-mPDC)₃] was obtained (80% yield, Calcd for C₂₁H₃₀N₆O₁₃Zn₄: C, 30.17; H, 3.62; N, 10.05. Found: C, 29.28; H, 4.45; N, 9.89.). Hereafter, this coordination polymer will be referred to as “Compound 2”.

### Method 2L

An attempt was made to scale up the fixation reaction of carbon dioxide. In this example, the reaction was performed in air without a glove box. In this example, DBU was also not used.

Specifically, a 1.5 L of DMF solution of Zn(OAc)₂-2H₂O (52.7 g, 2.4 mol) was mixed with a 1.5 L iPrOH solution of H₂[SmPZ] (18.0 g, 1.8 mol) in a 5 L medium bottle at 25° C. under air.in air. The bottle was sealed with a rubber septum. Thus, the material for carbon dioxide fixation for Example 2L was obtained.

Next, CO₂ gas (>99.99%) was flowed into the bottle at 25° C. and at atmospheric pressure. The white precipitate was formed (~15 min). The reaction mixture was stirred under CO₂ flowing for 3 days to complete the reaction. In visual observation, this reaction was almost complete in about 2 to 3 hours. In this way, carbon dioxide fixation was performed using the material for carbon dioxide fixation according to Example 2L.

The precipitate was collected by filtration and washed with DMF and iPrOH under air, and dried under vacuum at 80° C. Thus, the coordination polymer [Zn₄O(S-mPDC)₃] was obtained (ca. 50 g, 83% yield). Hereafter, this coordination polymer will be referred to as “Compound 2L”.

### Example 3

### Method 3

The procedure was followed by that of Method 2 using RmPZ instead of SmPZ. The reaction time by visual observation was almost the same as in Method 2. Thus, the coordination polymer [Zn₄O(P-mPDC)₃] was obtained (84% yield, Calcd for C₂₁H₃₀N₆O₁₃Zn₄: C, 30.17; H, 3.62; N, 10.05. Found: C, 29.26; H, 4.08; N, 9.87.). Hereafter, this coordination polymer will be referred to as “Compound 3”.

### Example 4

### Method 4

The procedure was followed by that of Method 2 using dmPZ instead of SmPZ. The reaction time by visual observation was almost the same as in Method 2. Thus, the coordination polymer [Zn₄O(dmPDC)₃] was obtained (84% yield, 59% yield, Calcd for C₂₄H₃₆N₆O₁₃Zn₄: C, 32.83; H, 4.13; N, 9.57. Found: C, 32.46; H, 4.66; N, 9.49.). Hereafter, this coordination polymer will be referred to as “Compound 4”.

### Example 5

### Method 5

First, a methanol solution of bpy (250 mM) and H₂PZ (500 mM) was added with stirring to a methanol solution of Cu(NO₃)₂·3H₂O (250 mM) at 25° C. and atmospheric pressure. Thus, the material for carbon dioxide fixation for Example 5 was obtained.

Next, CO₂ gas (>99.99%) was introduced with stirring into the resulting reaction mixture at 25° C. and atmospheric pressure. Precipitation was observed within minutes after the introduction of CO₂ gas. To complete the reaction, bubbling was continued for 12 hours to obtain precipitation. In visual observation, this reaction was almost complete in about 30 minutes to 1 hour. In this way, carbon dioxide fixation was performed using the material for carbon dioxide fixation according to Example 5.

The resulting precipitate was filtered off, washed with methanol, and dried in air. Thus, the coordination polymer was obtained. Hereafter, this coordination polymer will be referred to as “Compound 5”.

### Example 6

First, Zr-SBU was synthesized as a metal ion donor. This synthesis was performed according to the following literatures.

Reference 3: G. Kickelbick et al, Chem. Ber. 1997, 130, 473

The synthesis scheme of Zr-SBU is shown below.
[Chem 25]

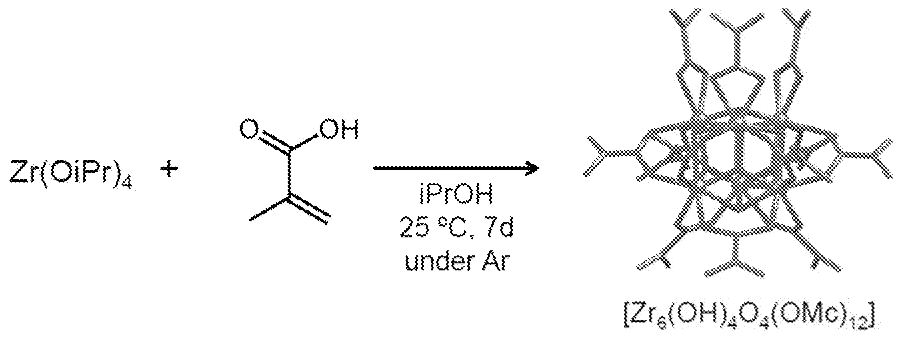

A DMF/ethanol solution of Zr-SBU (5 mM) was mixed with H₂PZ (30 mM), DBU (60 mM), and ammonium acetate (150 mM) under an Ar atmosphere, at 25° C. and atmospheric pressure. Thus, the material for carbon dioxide fixation for Example 6 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 8 hours to obtain precipitation. In visual observation, this reaction was almost complete in about 30 minutes to 1 hour. In this way, carbon dioxide fixation was performed using the material for carbon dioxide fixation according to Example 6. The white solid (coordination polymer) at this stage will be referred to as “Compound 6”.

The above white solid was filtered off, washed with ethanol, and dried in air. The coordination polymer obtained in this way will be referred to as “Compound 6′”.

### Example 7

### Method 7M

A DMF solution of Cu(OAc)₂·H₂O (40 mM) was mixed with a methanol solution of PZ-CO₂-DBU (40 mM) and dabco (20 mM) at 25° C. and atmospheric pressure. Precipitation was observed within minutes after mixing. The resulting powder was filtered, washed with methanol, and dried. In this way, a coordination polymer in which carbon dioxide is fixed was obtained. Hereafter, this coordination polymer will be referred to as “Compound 7M”.

### Method 7E

The procedure was followed by that of Method 7M using ethanol solution instead of methanol solution. The speed of precipitation formation was similar to that of Method 7M. The coordination polymer obtained in this way will be referred to as “Compound 7E”.

### Method 7iP

The procedure was followed by that of Method 7M using ethanol solution instead of isopropanol solution. The speed of precipitation formation was similar to that of Method 7M. The coordination polymer obtained in this way will be referred to as “Compound 7iP”.

### Example 8

### Method 8

An isopropanol solution of DP (30 mM) and DBU (120 mM) was mixed with a DMF solution of Zn(OAc)₂·2H₂O (40 mM) under an Ar atmosphere, at 25° C. and atmospheric pressure. Thus, the material for carbon dioxide fixation for Example 8 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 12 hours to obtain precipitation. In visual observation, this reaction was almost complete in about 30 minutes to 1 hour. In this way, carbon dioxide fixation was performed using the material for carbon dioxide fixation according to Example 8.

The resulting white solid was filtered off, washed with isopropanol, and dried in air. The coordination polymer obtained in this way will be referred to as “Compound 8”.

### Example 9 (Reference Example)

### Method 9

A MeCN solution of pXDA (100 mM) was added with stirring to a MeCN solution of Zn-SBU (10 mM) under an Ar atmosphere. The resulting reaction mixture was heated at 70° C. for 24 hours. The resulting white solid was isolated by centrifugation, washed with MeCN, and dried. The coordination polymer obtained in this way will be referred to as “Compound 9”. Note that in this Method 9, no CO₂-containing gas was used and CO₂ fixation was not performed.

### Example 10

### Method 10

First, a methanol solution of H₂PZ (500 mM) was added with stirring to a methanol solution of Cu(NO₃)₂·3H₂O (250 mM) at 25° C. and atmospheric pressure. Thus, the material for carbon dioxide fixation for Example 10 was obtained. The reaction mixture contained a purple precipitate. A portion of this precipitate was isolated for later analysis. This precipitate is hereafter referred to as “Compound 10P”.

The above reaction mixture was then bubbled with CO₂ gas (>99.99%) at 25° C. and atmospheric pressure for 3 hours with stirring. This gradually transformed the purple precipitate into a blue precipitate. In visual observation, this reaction was almost complete in about 30 minutes to 1 hour. In this way, carbon dioxide fixation was performed using the material for carbon dioxide fixation according to Example 10.

The resulting blue powder was filtered, washed with methanol, and dried. Thus, the coordination polymer was obtained. Hereafter, this coordination polymer will be referred to as “Compound 10”.

### Example 11

### Method 11

First, a methanol solution of H₂PZ (500 mM) was added with stirring to a methanol solution of MgNO₃·6H₂O (250 mM) at 25° C. and atmospheric pressure. Thus, the material for carbon dioxide fixation for Example 11 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 12 hours to obtain precipitation. In visual observation, this reaction was almost complete in about 30 minutes to 1 hour. In this way, carbon dioxide fixation was performed using the material for carbon dioxide fixation according to Example 11.

The resulting powder was filtered off, washed with methanol, and dried in air. Thus, the coordination polymer was obtained. Hereafter, this coordination polymer will be referred to as “Compound 11”.

### Example 12

### Method 12

To a methanol/DMF solution of Zn(OAc)₂·2H₂O (30 mM), tpt (20 mM) and DBU (120 mM) were added with stirring in air or under an Ar atmosphere at 25° C. and atmospheric pressure. Thus, the material for carbon dioxide fixation for Example 12 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 12 hours to obtain precipitation. In visual observation, this reaction was almost complete in about 30 minutes to 1 hour. In this way, carbon dioxide fixation was performed using the material for carbon dioxide fixation according to Example 12.

The resulting powder was filtered, washed with methanol, and dried. Thus, the coordination polymer was obtained. Hereafter, this coordination polymer will be referred to as “Compound 12”.

### Example 13

### Method 13

To a methanol/DMF solution of Cu(NO₃)₂·3H₂O (30 mM), tpt (20 mM) and DBU (120 mM) were added with stirring in air or under an Ar atmosphere at 25° C. and atmospheric pressure. Thus, the material for carbon dioxide fixation for Example 13 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 6 hours to obtain precipitation. In visual observation, this reaction was almost complete in about 30 minutes to 1 hour. In this way, carbon dioxide fixation was performed using the material for carbon dioxide fixation according to Example 13.

The resulting powder was filtered, washed with methanol, and dried. Thus, the coordination polymer was obtained. Hereafter, this coordination polymer will be referred to as “Compound 13”.

### Example 14

### Method 14

An isopropanol solution of pda (30 mM) and DBU (120 mM) was mixed with a DMF solution of Zn(OAc)₂·2H₂O (40 mM) under an Ar atmosphere, at 25° C. and atmospheric pressure. Thus, the material for carbon dioxide fixation for Example 14 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 24 hours to obtain precipitation. In visual observation, this reaction was almost complete in about 30 minutes to 1 hour. In this way, carbon dioxide fixation was performed using the material for carbon dioxide fixation according to Example 14.

The resulting white powder was filtered off, washed with isopropanol, and dried. Thus, the coordination polymer was obtained. Hereafter, this coordination polymer will be referred to as “Compound 14”.

### Example 15

### Method 15

An ethanol solution of eda (100 mM) and DBU (400 mM) was mixed with a DMF solution of Zn(OAc)₂·2H₂O (50 mM) under an Ar atmosphere, at 25° C. and atmospheric pressure. Thus, the material for carbon dioxide fixation for Example 15 was obtained.

Next, CO₂ gas (>99.99%) was introduced into the resulting reaction mixture at 25° C. and atmospheric pressure. Precipitation was observed within minutes after the introduction of CO₂ gas. To complete the reaction, bubbling was continued for 12 hours to obtain precipitation. In visual observation, this reaction was almost complete in about 30 minutes to 1 hour. In this way, carbon dioxide fixation was performed using the material for carbon dioxide fixation according to Example 15.

The resulting white powder was filtered, washed with ethanol, and dried. Thus, the coordination polymer was obtained. Hereafter, this coordination polymer will be referred to as “Compound 15”.

### Example 16

### Method 16

An aqueous solution of MnCl₂·4H₂O (50 mM) was mixed with a 35% HZ solution at 25° C. and atmospheric pressure. Thus, the material for carbon dioxide fixation for Example 16 was obtained.

The resulting light orange suspension was bubbled with CO₂ gas (>99.99%) at 25° C. and atmospheric pressure for 1 hour with stirring to obtain a clear colorless aqueous solution. Water was removed by an evaporator to obtain a white powder. In this way, carbon dioxide fixation was performed using the material for carbon dioxide fixation according to Example 16. The coordination polymer obtained in this way will be referred to as “Compound 16”.

As described above, in Methods 1, 1C, 1D, 2, 2L, 3 through 6, 8, 11 through 16, solid formation was observed by introducing a gas containing carbon dioxide into a homogeneous solution containing a metal ion donor and an amine. In Method 10, the formation of new solids of different colors was observed by introducing a gas containing carbon dioxide into the solid obtained from the reaction of a metal ion donor with an amine. Furthermore, in Methods 1A, 1B, 7M, 7E, and 7iP, solid formation was observed by mixing an amine solution with a solution of a metal ion donor, in which a gas containing carbon dioxide was introduced. These observed facts indicate that the introduction of carbon dioxide-containing gases directly or indirectly caused cross-linking between metal ions and carbamate ligands, resulting in the formation of polymer structures.

As can be seen from Examples 1-8 and 10-16 above, the combination of a metal ion donor and an amine configured to react with gaseous carbon dioxide to form a bridging ligand with at least one carbamate anion moiety could be used to fix carbon dioxide under mild conditions and at high efficiency, with the synthesis of a coordination polymer. In particular, as noted above, the fixation of carbon dioxide for Examples 1 through 8 and 10 through 16 could be performed at room temperature and atmospheric pressure.

In the fixation of carbon dioxide for Examples 1 through 8 and 11 through 15, precipitation occurred immediately or within a very short period of time by the introduction of gas containing carbon dioxide or by mixing with an amine solution in which carbon dioxide-containing gas was introduced. These observed facts suggest that in each of the above examples, the fixation of carbon dioxide by the formation of coordination polymers was achieved at a very high rate.

Furthermore, Example 1D in particular was able to fix carbon dioxide from air. In addition, Example 2L was able to fix carbon dioxide on a large scale and in air for a short period of time. These examples suggest the high versatility of the material and method for carbon dioxide fixation according to the present invention.

### Evaluation of Structural and Physical Properties

The obtained compounds 1 through 16 were evaluated for structural and physical properties.

### Example 1 to Example 4

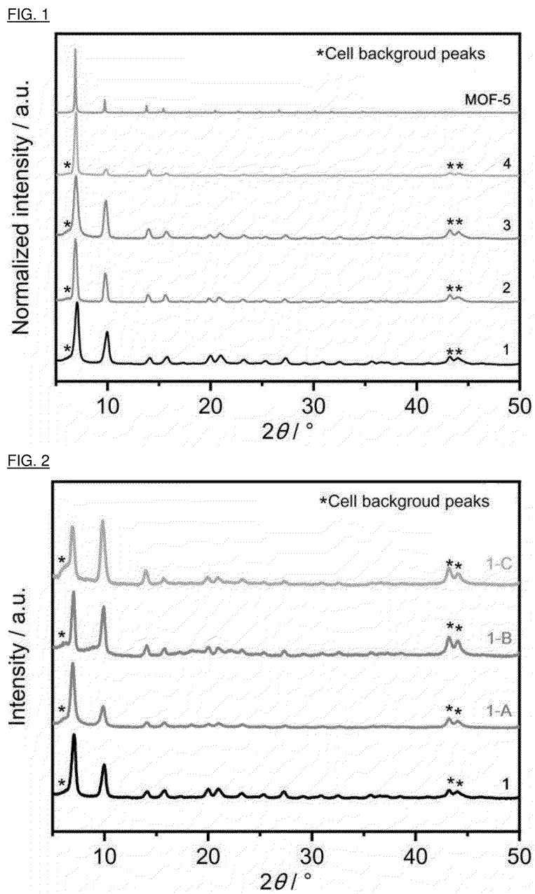

Powder X-ray diffraction (PXRD) measurements were performed on compounds 1 through 4. The PXRD measurements were performed by Rigaku MiniFlex with a CuKa anode. The measurements were also performed under an Ar atmosphere. The results are shown in FIG. 1, along with the simulation pattern of MOF-5.

FIG. 1 shows the PXRD patterns of compounds 1 through 4 and MOF-5. As can be seen from FIG. 1, compounds 1 through 4 had periodic structures similar to MOF-5. The detailed crystal structure analysis of compounds 1 through 4 will be discussed in more detail later.

PXRD measurements were performed on compounds 1, 1A, 1B and 1C. These results are summarized in FIG. 2.

FIG. 2 shows the PXRD patterns of compounds 1, 1A, 1B, and 1C. As can be seen from FIG. 2, compounds 1, 1A, 1B, and 1C had periodic structures similar to each other. The results suggest that carbon dioxide fixation by various methods is effective.

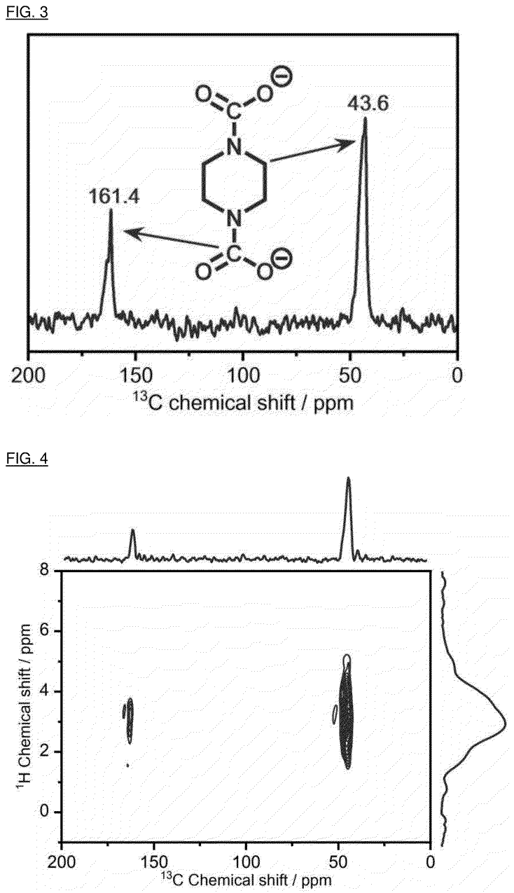

Solid-state nuclear magnetic resonance (SSNMR) measurements were performed to confirm the formation of PDC from H₂PZ and CO₂. The SSNMR measurements were performed using JNM-ECZ600R. Specifically, 1D ¹³C CP-MAS (Cross-Polarization Magic Angle Spinning) SSNMR measurements and 2D ¹H-¹³C HETCOR (Heteronuclear Correlation) SSNMR measurements were performed on compound 1. These measurements were performed under an Ar atmosphere. The results are shown in FIGS. 3 and 4.

FIG. 3 shows the 1D ¹³C CP-MAS SSNMR spectrum of compound 1. As shown in FIG. 3, the SSNMR spectrum had peaks at 43.6 and 161.4 ppm. The ¹³C peak at 161.4 ppm fits well with the peak (literature value) of the carbon atom of the carbamate anion (NCO₂⁻).

FIG. 4 shows the 2D ¹H-¹³C HETCOR SSNMR spectrum of compound 1. As FIG. 4 shows, the aliphatic proton of piperazine (—CH₂—) correlated not only with the covalent carbon (43.6 ppm) but also with the carbon atom of the carbamate anion (161.4 ppm). This result suggests that PDC is formed in compound 1.

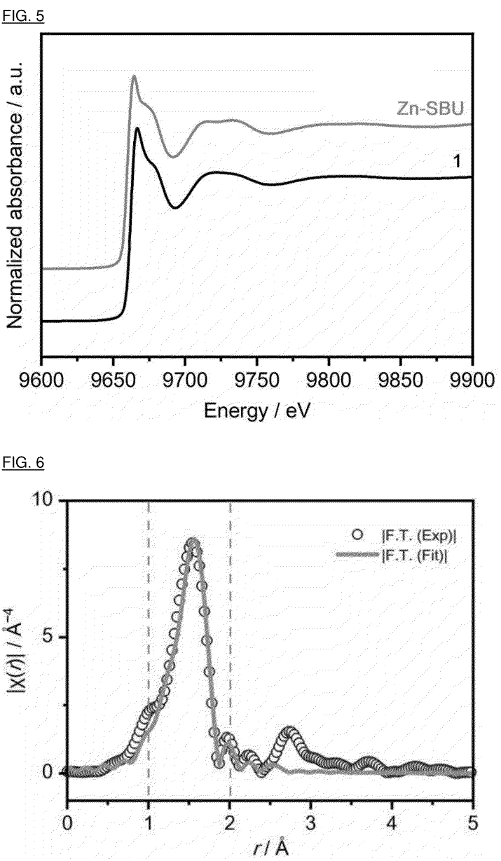

Synchrotron X-ray absorption spectroscopy (XAS) measurements were performed to investigate the coordination form of Zn²⁺ in compound 1. XAS measurements were performed at BL1.1W at the Synchrotron Light Research Institute in Thailand. Specifically, the K-edge (9659 eV) spectrum of Zn was measured in fluorescence mode using a Si (111) double crystal monochromator. The measurements were performed under an Ar atmosphere. The Zn K-edge XANES (X-ray absorption near edge structure) spectra were obtained in this way. The results are shown in FIG. 5.

FIG. 5 shows the Zn K-edge XANES spectra of compound 1 and Zn-SBU. As shown in FIG. 5, compound 1 had almost the same spectrum as Zn-SBU. In other words, it was suggested that a cluster structure similar to that of Zn-SBU exists in compound 1.

To obtain further information on the first coordination shell of Zn, a quantitative analysis by Extended X-ray Absorption Fine Structure (EXAFS) was performed. The results are shown in FIG. 6.

FIG. 6 shows the Zn K-edge EXAFS spectrum of compound 1. In FIG. 6, the data points indicated by circles are experimental values, the solid line is curve fitting, and the dashed line means the fitting range (1.0 to 2.0 Å). From the results shown in FIG. 6, the coordination number of Zn was determined to be 3.7±0.2. This result suggests the presence of a tetrahedral Zn-4O structure in compound 1.

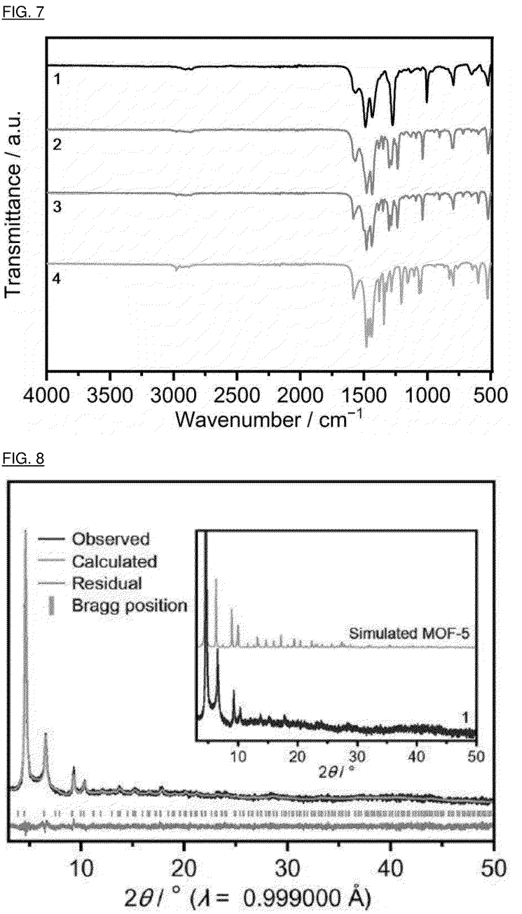

Fourier transform infrared spectroscopy (FT-IR) measurements were performed on compounds 1 through 4. IR measurements were performed using Bruker Optics ALPHA. These measurements were performed under an Ar atmosphere. The results are shown in FIG. 7.

FIG. 7 shows the FT-IR spectra of compounds 1 through 4. As can be seen from FIG. 7, compounds 1 through 4 had characteristic peaks in the 521-525 cm⁻¹ range. This peak fits well with the peak of the µ₄-O-Zn stretching vibration of the [Zn₄O(CO₂)₆] cluster.

As mentioned above, the EXAFS and FT-IR measurements indicate the presence of [Zn₄O(CO₂)₆] clusters in compounds 1 through 4.

Synchrotron PXRD measurements were performed to establish the crystal structures of compounds 1 through 4. This measurement was performed using the BL02B2 beamline of the Super Photon Ring (SPring-8). The sample was a powder sealed in a glass tube in a glove box in an Ar atmosphere. Since the above SSNMR, XAS, and FT-IR results indicate the presence of [Zn₄O(CO₂)₆] and PDC in compound 1, a structure with PDC replacing BDC in MOF-5 as a crystal model was assumed and Rietveld analysis was performed. The results are shown in FIGS. 8 through 10 and Table 3.

FIG. 8 shows the results of the Rietveld analysis of compound 1. FIG. 8 also shows the PXRD pattern of compound 1 and the simulated pattern of MOF-5. Table 3 shows crystal data and refinement details for compounds 1 through 4. As shown in FIG. 8 and Table 3, compound 1 was found to be isostructural with MOF-5. Compounds 2 through 4 were also found to be isostructural to MOF-5, as shown in Table 3. The determined cell length of compound 1 (24.7739 Å) was shorter than the cell length of MOF-5 (25.6690 Å), which conformed well to the difference between the PDC (5.5 Å) and BDC (5.7 Å).

TABLE 3

| | | | | |
|---|---|---|---|---|
| Compound | 1 | 2 | 3 | 4 |
| Formula | C₁₈N₆O₁₃Zn₄ | C₂₁N₆O₁₃ZN₄ | C₂₁N₆O₁₃Zn₄ | C₂₄N₆O₁₃Zn₄ |
| T/K | 298 | | | |
| Wavelength/Å | 0.999000 | | | |
| 2θ range / ° | 2.1 - 78.2 | | | |
| Crystal system | Cubic | | | |
| Space group | Fm-3m | | | |
| a / Å | 24.7739 | 24.8572 | 24.8893 | 24.8597 |
| V / Å³ | 15205 | 15359 | 15418 | 15363 |
| Z | 8 | | | |
| Number of reflection | 864 | 877 | 881 | 877 |
| Rₚ | 0.0307 | 0.0328 | 0.0321 | 0.0326 |
| R_{wp} | 0.0390 | 0.0436 | 0.0411 | 0.0428 |
| S | 3.89 | 5.34 | 5.39 | 4.14 |

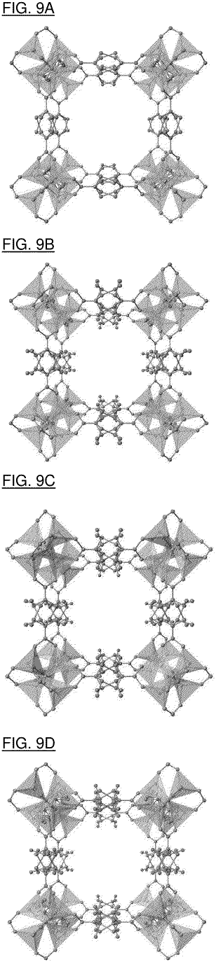

FIGS. 9A through 9D show the packing structures of compounds 1 through 4, respectively. In each figure, the bridging ligand shows static disorder. FIGS. 9A through 9D also show that compounds 1 through 4 have the same porous structure as MOF-5.

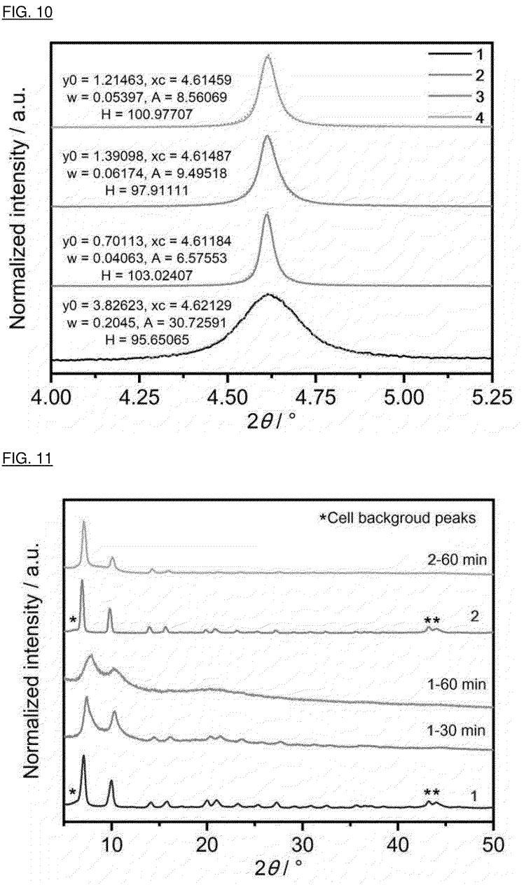

FIG. 10 shows the analysis of the first Bragg peaks of compounds 1 through 4. The calculated Full-Width-Half-Maximum (FWHM) in FIG. 10 were as follows.
Compound 1: 0.205°
Compound 2: 0.0406°
Compound 3: 0.0617°
Compound 4: 0.0540°

As such, compound 2 was found to have the highest crystallinity.

From the crystal structure and compositional formula determined above, the amount of CO₂ introduced into compounds 1 through 4 were as follows.
Compound 1: 33.3% by mass
Compound 2: 31.6% by mass
Compound 3: 31.6% by mass
Compound 4: 30.1% by mass

As such, the synthesis of compounds 1 through 4 resulted in highly efficient fixation of CO₂.

Time-dependent PXRD measurements were performed to evaluate the stability of compounds 1 and 2 in air. This measurement was performed at 25° C. and 50 RH%. The results are shown in FIG. 11.

FIG. 11 shows the change in PXRD patterns of compounds 1 and 2 in air. In FIG. 11, “1 -30 min” shows the PXRD pattern after 30 minutes of removing compound 1 from Ar atmosphere to air, “1-60min” shows the PXRD pattern after 60 minutes of removing compound 1 from Ar atmosphere to air, and “2-60 min” shows the PXRD pattern after 60 minutes of removal of compound 1 from Ar atmosphere into air. As can be seen from FIG. 11, compound 2 was more stable to air or moisture than compound 1. This may be attributed to the introduction of hydrophobic methyl groups in the bridging ligands of compound 2, which makes it difficult for H₂O molecules to diffuse into the pores.

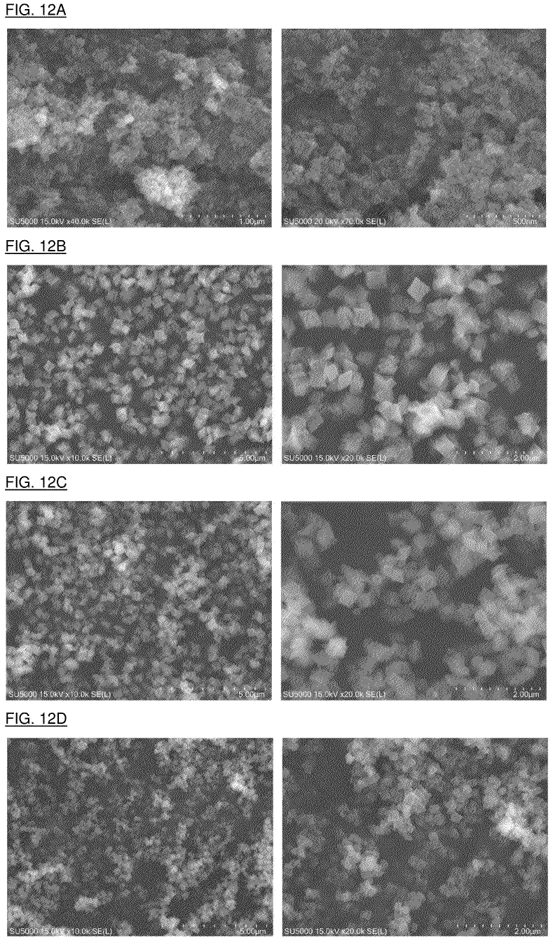

To examine the morphology of compounds 1 through 4, scanning electron microscopy (SEM) was used. This SEM observation was performed using a Hitachi SU5000. Measurements were made by quickly observing the samples in air after activation. The results are shown in FIG. 12.

FIGS. 12A through 12D show SEM images of compounds 1 through 4, respectively. As can be seen from FIGS. 12A through 12D, although small particles (~60 nm) agglomerated in compound 1, compound 2 (200-500 nm), compound 3 (200-500 nm), and compound 4 (200-300 nm) produced cubic-shaped particles with little agglomeration. This result may be attributed to the steric hindrance caused by the methyl groups in the bridging ligand, which controls the reaction kinetics of carbamate formation, resulting in excellent particle morphology and high crystallinity. The particle morphology of compounds 2 through 4 was also similar to that of MOF-5 obtained by hydrothermal synthesis (>500 µm).

To evaluate the scalability of the carbon dioxide fixation method described above, a comparison was made between Compound 2L and Compound 2. Specifically, PXRD measurements were performed on both compounds. The results are shown in FIG. 13. As noted above, compound 2L is a coordination polymer obtained by reaction on a large scale, in air, and in an undehydrated solvent.

FIG. 13 shows the PXRD pattern of compound 2L. As can be seen from the comparison between FIG. 13 and FIG. 1, the PXRD pattern of compound 2L fits well with the PXRD pattern of compound 2. The results indicate that the carbon dioxide fixation described above does not require severe dehydration conditions.

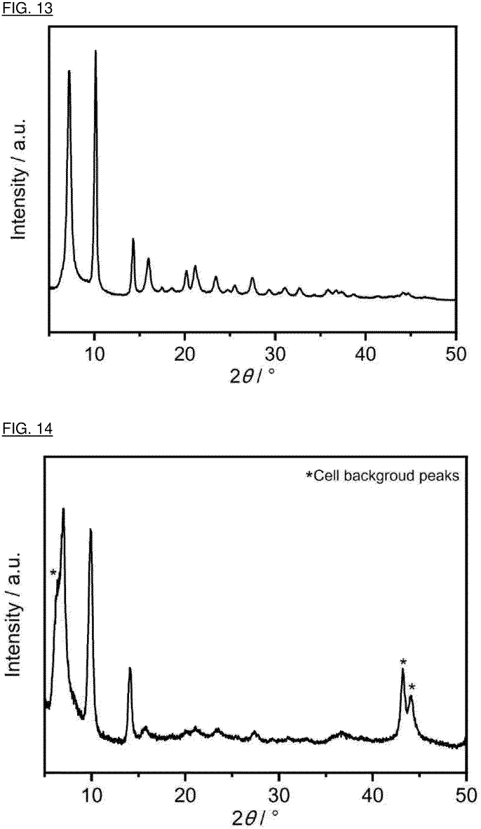

To confirm that the fixation of carbon dioxide described above can be achieved even with gases with low carbon dioxide content, a comparison was made between Compound 1D and Compound 1. Specifically, PXRD measurements were performed on both compounds. The results are shown in FIG. 14. As mentioned above, Compound 1D is a coordination polymer obtained by fixing carbon dioxide using air (CO₂ concentration: 400 ppm).

FIG. 14 shows the PXRD pattern of compound 1D. As can be seen from the comparison between FIG. 14 and FIG. 1, the PXRD pattern of compound 1D fits well with the PXRD pattern of compound 1, although the crystallinity is slightly lower. The results show that the above mentioned fixation of carbon dioxide can be achieved even with gases with low carbon dioxide content, such as air.

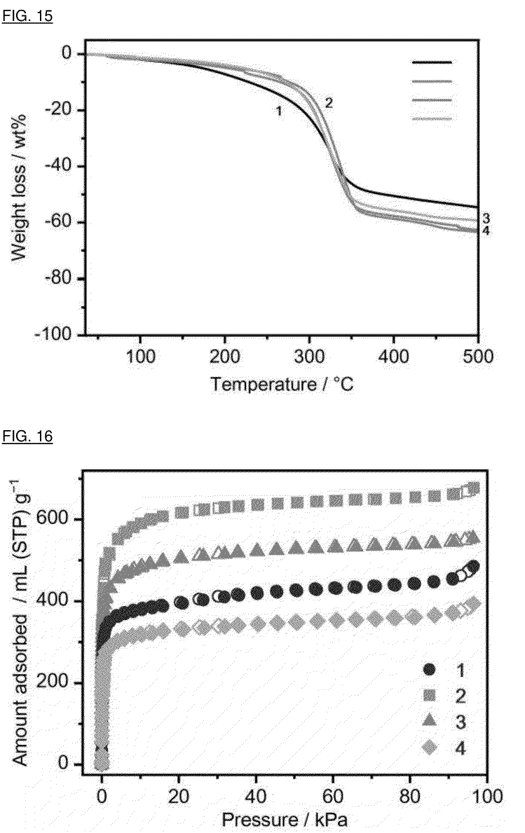

The thermal stability of compounds 1 through 4 was evaluated. That is, Thermogravimetric Analysis (TGA) measurements were performed for compounds 1 through 4. This TGA measurement was performed using a Rigaku Thermo plus TG 8121. The temperature range was 40° C. to 500° C. and the heating rate was 10° C./min. The measurements were performed under an Ar atmosphere. The results are shown in FIG. 15.

FIG. 15 shows the TGA profiles of compounds 1 through 4 under Ar atmosphere. As shown in FIG. 15, compounds 1 through 4 have excellent thermal stability. The stabilization of the carbamate structure by coordination to metal ions will be discussed in more detail later.

The porosity of compounds 1 through 4 was evaluated. That is, gas adsorption measurements were performed for compounds 1 through 4. The gas adsorption measurements were performed using BELSORP-max. Prior to gas adsorption measurements, samples were activated at 80° C. in a vacuum.

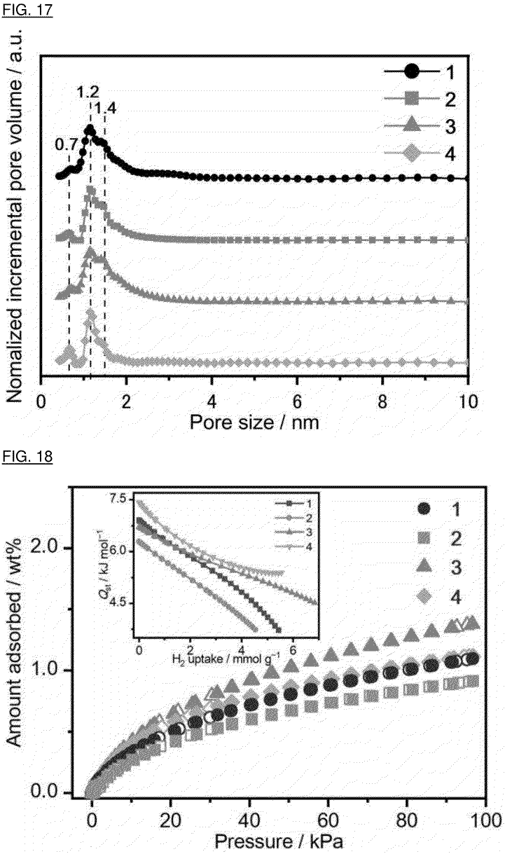

FIG. 16 shows the nitrogen adsorption isotherms at 77 K for compounds 1 through 4. In the adsorption isotherms shown below, the filled data points indicate the amount of adsorption at boost pressure, and the white data points indicate the amount of adsorption at buck pressure. As can be seen from FIG. 16, compounds 1 through 4 showed sharp increases in nitrogen adsorption at low pressure. This suggested the presence of micropores in compounds 1 through 4.

The BET specific surface area obtained from the nitrogen adsorption isotherm at 77 K were calculated as follows.
Compound 1: 1525 m²/g
Compound 2: 2366 m²/g
Compound 3: 1943 m²/g
Compound 4: 1270 m²/g.

These values are about in the middle range in the reported BET specific surface area of MOF-5 (570-3800 m²/g). The difference in BET specific surface area between compounds 1 through 4 and MOF-5 can be attributed to the fact that PDC as a bridging ligand is slightly bulkier than BDC. The particularly large BET specific surface area of compound 2 can be attributed to its high crystallinity.

FIG. 17 shows the pore size distribution of compounds 1 through 4. The pore size distribution was calculated by the NLDFT (Non-Localized Density Functional Theory) model based on nitrogen adsorption isotherms. As can be seen from FIG. 17, compounds 1 through 4 all had a pore size of mainly 1.2 nm. This value fits well with the pore size of MOF-5 (1.4 nm).

FIG. 18 shows the hydrogen adsorption isotherms at 77 K and the isosteric heat of adsorption curves for the amount of hydrogen adsorbed for compounds 1 through 4. As shown in FIG. 18, compounds 1 through 4 exhibited moderate hydrogen adsorption (0.9 to 1.4 mass%).

From the hydrogen adsorption isotherms at 77 K (FIG. 18) and 88 K (not shown), the zero coverage adsorption enthalpies Qₛₜ of compounds 1 through 4 were determined by Virial fitting. The resulting Qₛₜ for hydrogen adsorption were calculated as follows.
Compound 1: 6.9 kJ/mol
Compound 2: 6.3 kJ/mol
Compound 3: 6.7 kJ/mol
Compound 4: 7.4 kJ/mol.

These values were higher than the Qₛₜ values for MOF-5 (3.8-4.8 kJ/mol). The Qₛₜ of compound 4, which has the smallest pore size, was the highest, suggesting that the reason why the Qₛₜ of compounds 1 through 4 is higher than that of MOF-5 is due to the interaction of adjacent H₂ molecules in the smaller pores.

FIG. 19 shows the carbon dioxide adsorption isotherms at 195 K for compounds 1 through 4. As shown in FIG. 19, the amount of carbon dioxide adsorption of compounds 1 through 4 were as follows.
Compound 1: 353 cm³/g
Compound 2: 187 cm³/g
Compound 3: 429 cm³/g
Compound 4: 296 cm³/g

As such, all of these compounds had excellent carbon dioxide adsorption capacity. Among the compounds 1 through 4, compound 3 showed the highest carbon dioxide adsorption.

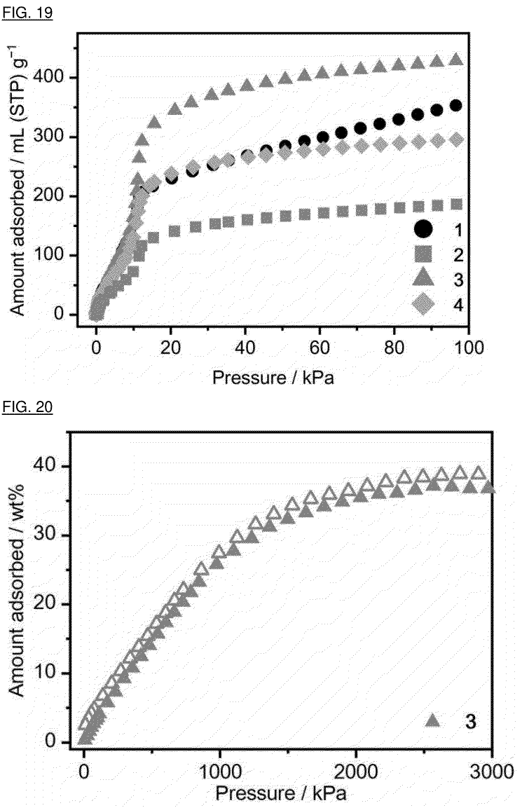

FIG. 20 shows the high-pressure carbon dioxide adsorption isotherm at 298 K for compound 3. The adsorption isotherm was saturated at 2.6 MPa, and the maximum adsorption of CO₂ was 37.2 mass%. That is, the total CO₂ content of compound 3 completely filled with CO₂ was 68.8 mass% (31.6 mass% as carbamate moiety and 37.2 mass% as adsorbent). This CO₂ content is as high as one-third the density of solid CO₂ (dry ice) (1.562 g/cm³ at 195 K and 0.1 MPa).

The adsorption properties and CO₂ content of compounds 1 through 4 are summarized in Table 4.

TABLE 4

| | | | | |
|---|---|---|---|---|
| Compound | 1 | 2 | 3 | 4 |
| N₂ uptake@77 K / mL g⁻¹ | 486 | 677 | 544 | 394 |
| H₂ uptake@77 K / mL g⁻¹ | 122 | 97 | 153 | 124 |
| H₂ uptake@87 K / mL g⁻¹ | 77 | 67 | 98 | 83 |
| CO₂ uptake@195 K / mL g⁻¹ | 353 | 187 | 429 | 296 |
| CO₂ uptake@298 K / wt% | N.A. | N.A. | 37.2 (2.6 MPa) | N.A. |
| BET surface area / m² g⁻¹ | 152.5 | 2366 | 1943 | 1270 |
| Qₛₜ for H₂ adsorption / kJ mol⁻¹ | 6.9 | 6.3 | 6.7 | 7.4 |

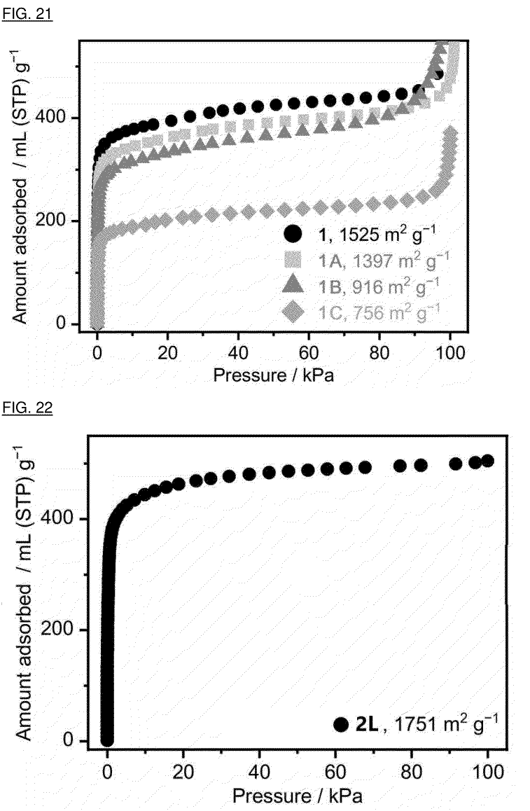

Gas adsorption measurements were performed on compounds 1, 1A, 1B, and 1C to determine the effect of different synthesis methods on gas adsorption performance. The results are shown in FIG. 21.

FIG. 21 shows the nitrogen adsorption isotherms of compounds 1, 1A, 1B, and 1C at 77 K. As can be seen from FIG. 21, the BET specific surface areas were larger in the order of compounds 1C < 1B < 1A < 1.

Similarly, gas adsorption measurements were performed on compound 2L to determine the effect of different synthesis methods on gas adsorption performance. The results are shown in FIG. 22.

FIG. 22 shows the nitrogen adsorption isotherm at 77 K for compound 2L. Comparison of FIG. 22 with FIG. 16 shows that the BET specific surface areas were larger in the order of compound 2L < 2.

### Example 5

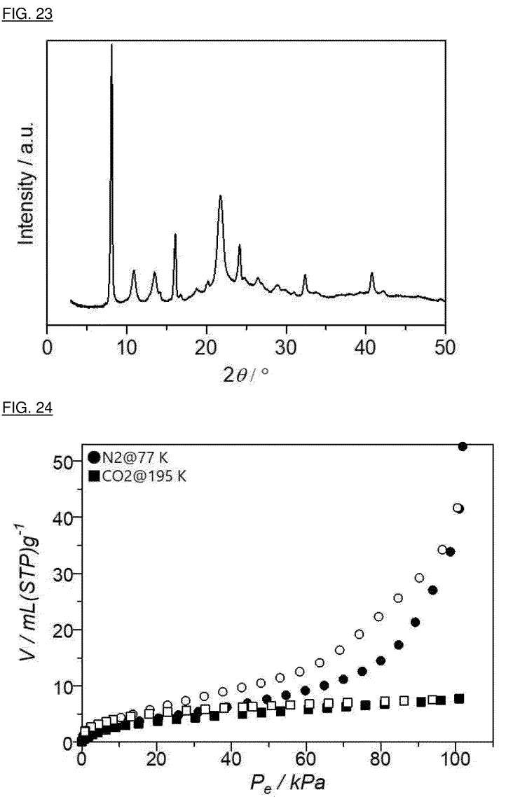

Powder X-ray diffraction (PXRD) measurements were performed on compound 5. The results are shown in FIG. 23.

FIG. 23 shows the PXRD pattern of compound 5. As can be seen from FIG. 23, compound 5 was highly crystalline. The presence of peaks at low angles suggests the formation of a coordination polymer network. In particular, the PXRD pattern of compound 5 is similar to that of Cu-JAST (not shown), suggesting that compound 5 is isostructural to Cu-JAST.

Gas adsorption measurements were performed for compound 5. The results are shown in FIG. 24.

FIG. 24 shows the nitrogen adsorption isotherm at 77 K and the carbon dioxide adsorption isotherm at 195 K for compound 5. The BET specific surface area calculated from the former is 18.5 m²/g, indicating that compound 5 is porous.

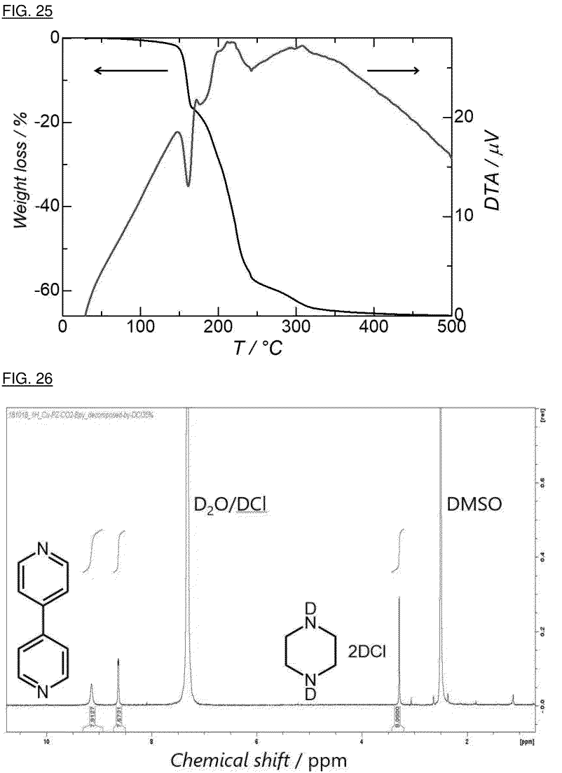

TGA measurements were performed on compound 5. The results are shown in FIG. 25.

FIG. 25 shows the TGA-DTA profile of compound 5. As shown in FIG. 25, compound 5 is stable up to around 150° C., indicating that it has good thermal stability.

Solution NMR measurements were performed to confirm the presence of carbamate ligands and auxiliary ligands in compound 5. The solution NMR measurements were performed at 25° C. using a Bruker Avance III. Specifically, compound 5 was decomposed in DCI/D₂O (35%) and NMR measurements in DMSO-d₆ were performed on the resulting solution.

FIG. 26 shows the solution NMR spectrum of compound 5. As can be seen from FIG. 26, when compound 5 was decomposed, the presence of PZ and bpy was confirmed. The molar ratio of PZ to bpy was 1:2. These observations suggest that compound 5 is indeed formed from two different ligands and has a composition similar to Cu-JAST.

### Example 6

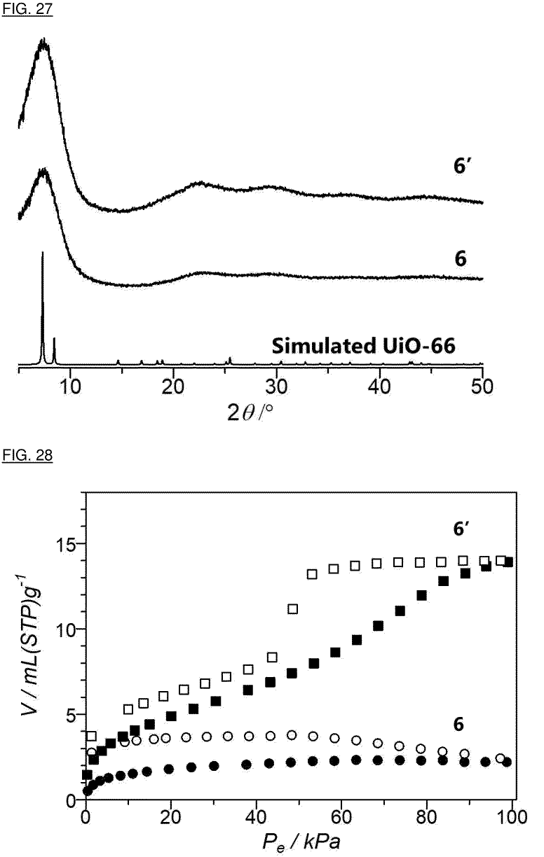

Powder X-ray diffraction (PXRD) measurements were performed on compounds 6 and 6′ in air. The results are shown in FIG. 27, along with the simulation pattern of UiO-66.

FIG. 27 shows the PXRD patterns of compounds 6 and 6′ and UiO-66. As can be seen in FIG. 27, although the crystallinity of compounds 6 and 6′ was not very high, the broad peaks at low angles are similar to those of UiO-66, suggesting the presence of a network structure similar to that of UiO-66.

Gas adsorption measurements were performed for compounds 6 and 6′. These results are summarized in FIG. 28.

FIG. 28 shows the nitrogen adsorption isotherms at 77 K for compounds 6 and 6′. The BET specific surface area calculated from the latter was 18. 6 m²/g, indicating that compound 6′ is porous. In particular, compound 6′ exhibited hysteresis in adsorption-desorption, suggesting the presence of micropores.

FT-IR measurements were performed on compounds 6 and 6′. The results are shown in FIG. 29, along with the results for Compound 1 and Zr-SBU.

FIG. 29 shows the FT-IR spectra of compounds 6 and 6′, compound 1, and Zr-SBU. As shown in FIG. 29, compounds 6 and 6′ exhibited FT-IR spectra similar to those of compound 1. The results suggest that compounds 6 and 6′, like compound 1, contain a carbamate ligand, PDC. Compounds 6 and 6′ also showed FT-IR spectra similar to those of Zr-SBU. The results suggest that compounds 6 and 6′ retain the Zr cluster structure.

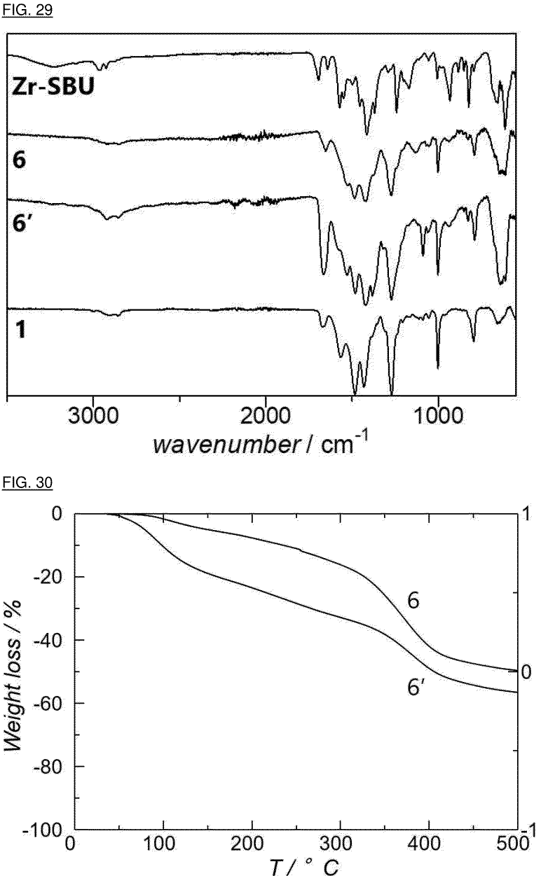

TGA measurements were performed on compounds 6 and 6′. The results are shown in FIG. 30.

FIG. 30 shows the TGA profiles of compounds 6 and 6′. As shown in FIG. 30, the internal solvent was removed at around 130° C. for compounds 6 and 6′, indicating that they have moderate thermal stability.

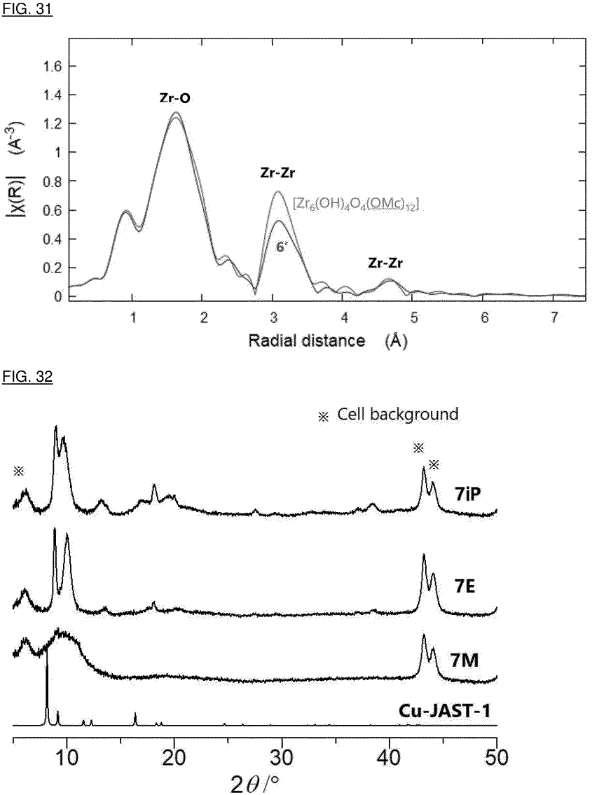

EXAFS measurements were performed on compound 6′. The results are shown in FIG. 31, along with the measurement results for Zr-SBU.

FIG. 31 shows the Zr K-edge EXAFS spectra of compound 6′ and Zr-SBU. As shown in FIG. 31, compound 6′ had an EXAFS spectrum similar to that of Zr-SBU. The results show that compound 6′ retains a cluster structure similar to that of Zr-SBU.

### Example 7

Powder X-ray diffraction (PXRD) measurements were performed on compounds 7M, 7E, and 7iP under Ar atmosphere. The results are shown in FIG. 32, along with the simulation pattern of Cu-JAST-1.

FIG. 32 shows the PXRD patterns of compounds 7M, 7E, and 7iP, and Cu-JAST-1. As can be seen from FIG. 32, compounds 7E and 7iP were highly crystalline and had PXRD patterns similar to Cu-JAST-1. Although compound 7M is not highly crystalline, its broad peaks at low angles are similar to those of Cu-JAST-1, suggesting the presence of a network structure similar to that of Cu-JAST-1.

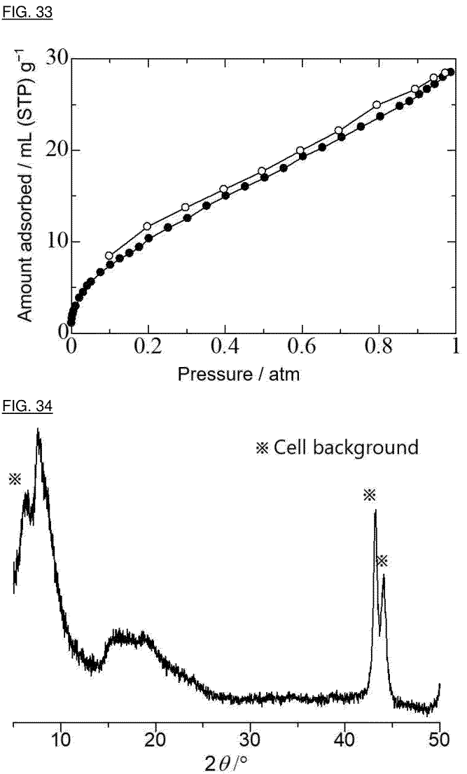

Gas adsorption measurements were performed for compound 7E. These results are summarized in FIG. 33.

FIG. 33 shows the carbon dioxide adsorption isotherm at 195 K for compound 7E. As shown in FIG. 33, the amount of carbon dioxide adsorbed at 1 atm was 29 cm³/g, indicating that compound 7E is porous. The adsorption isotherm profiles suggest that compound 7E has micropores, but the pore uniformity is not very high.

### Example 8

Powder X-ray diffraction (PXRD) measurements were performed on compound 8 under Ar atmosphere. These results are summarized in FIG. 34.

FIG. 34 shows the PXRD pattern of compound 8. As can be seen in FIG. 34, although the crystallinity of compound 8 was not high, it shows a large peak at low angles, suggesting the presence of long-range order due to the coordination polymer structure.

Gas adsorption measurements were performed for compound 8. The results are shown in FIG. 35.

FIG. 35 shows the carbon dioxide adsorption isotherm at 195 K for compound 8. As shown in FIG. 35, the amount of carbon dioxide adsorbed at 1 atm was 52 cm³/g, indicating that compound 8 is porous. The profile of the adsorption isotherm rose significantly from low pressure, suggesting that compound 8 has a typical micropore structure.

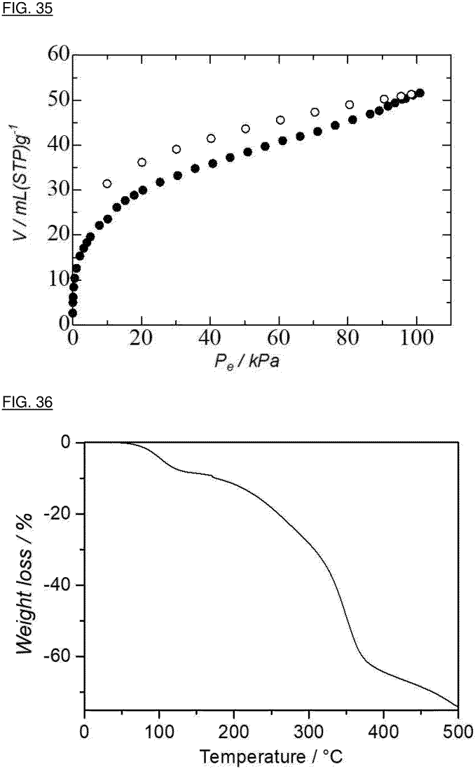

TGA measurements were performed on compound 8. The results are shown in FIG. 36.

FIG. 36 shows the TGA profile of compound 8. As shown in FIG. 36, compound 8 showed moderate thermal stability, with internal solvent removal at around 120° C.

### Example 9

Powder X-ray diffraction (PXRD) measurements were performed on compound 9. This measurement was performed both before and after gas adsorption. For the post-gas adsorption measurements, samples were used after nitrogen adsorption measurement at 77 K and carbon dioxide adsorption measurement at 195 K. The results are shown in FIG. 37.

FIG. 37 shows PXRD patterns of compound 9 before and after gas adsorption. As shown in FIG. 37, compound 9 is highly crystalline, and its crystal structure does not change after adsorption of the gas. The presence of peaks at low angles suggests the formation of a coordination polymer network.

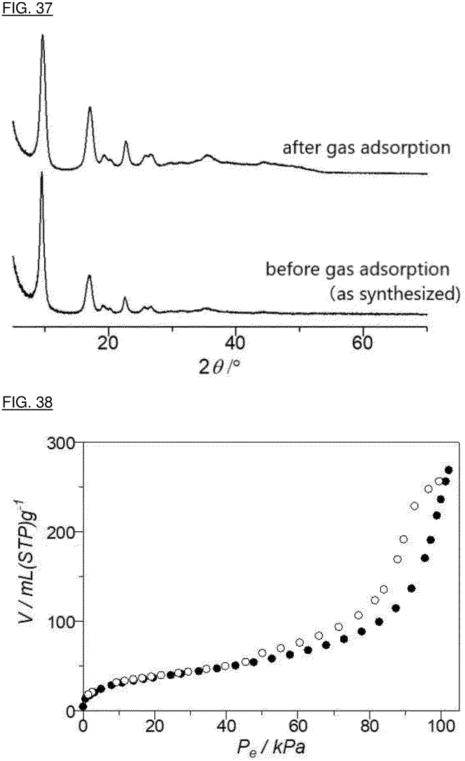

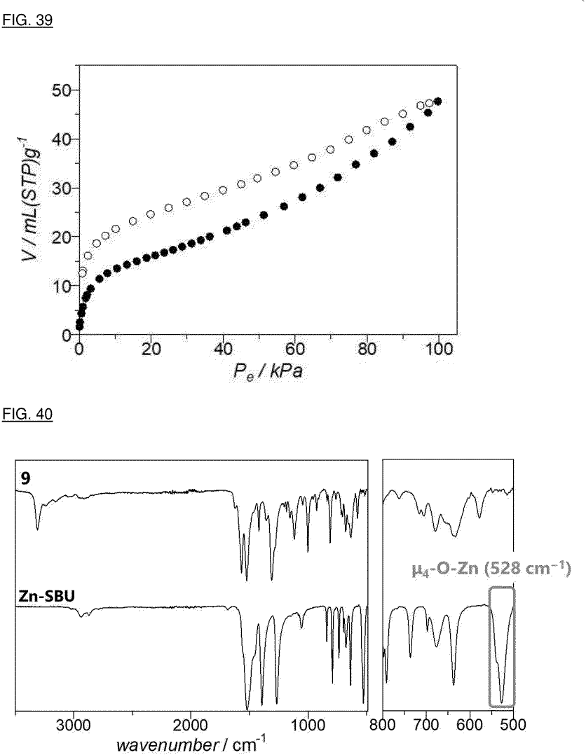

Gas adsorption measurements were performed for compound 9. The results are shown in FIGS. 38 and 39.

FIG. 38 shows the nitrogen adsorption isotherm at 77 K for compound 9. FIG. 39 shows the carbon dioxide adsorption isotherm at 195 K for compound 9. The BET specific surface area calculated from the former is 140 m²/g, and the CO₂ adsorption capacity indicated from the latter is 48 cm³/g. That is, the results shown in FIGS. 38 and 39 indicate that compound 9 is porous. The adsorption profiles shown in FIGS. 38 and 39 suggest that compound 9 has both micropores and mesopores.

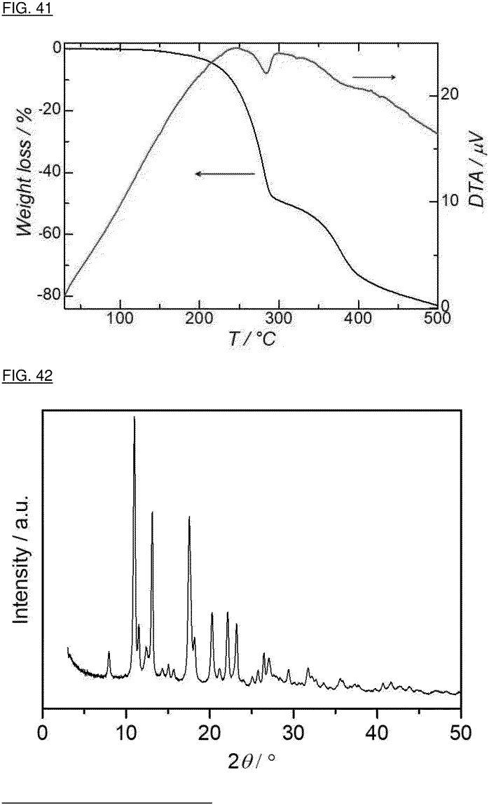

FT-IR measurements were performed on compound 9 under an Ar atmosphere. The results are shown in FIG. 40, along with the measurement results for Zn-SBU, which was also used as a raw material.

FIG. 40 shows the FT-IR spectra of compound 9 and Zn-SBU. As shown in FIG. 40, no peaks corresponding to Zn₄O clusters were detected in compound 9. This result suggests that compound 9 has a different structure from compound 1 and others.

TGA measurements were performed on compound 9. The results are shown in FIG. 41.

FIG. 41 shows the TGA-DTA profile of compound 9. As shown in FIG. 41, compound 9 is stable up to around 200° C., indicating that it has excellent thermal stability.

### Example 10

Powder X-ray diffraction (PXRD) measurements were performed on compound 10 and its precursor, compound 10P. The results are shown in FIGS. 42 and 43.

FIG. 42 shows the PXRD pattern of compound 10. As can be seen from FIG. 42, compound 10 was highly crystalline. The presence of peaks at low angles suggests the formation of a coordination polymer network.

FIG. 43 shows the PXRD patterns of compound 10, a coordination polymer with similar structures, and compound 10P. A coordination polymer with a similar structure is the compound described in Reference 4 below, which is a coordination polymer containing a Cu²⁺ paddlewheel unit and 1,4-cyclohexanedicarboxylic acid. As shown in FIG. 43, compound 10 is presumed to have a one-dimensional chain-like structure similar to this coordination polymer. Comparison of the PXRD patterns of compound 10 and compound 10P showed that they have completely different structures.

Reference 4: H. Kumagai et al. Inorg. Chem. 2007, 46, 5949

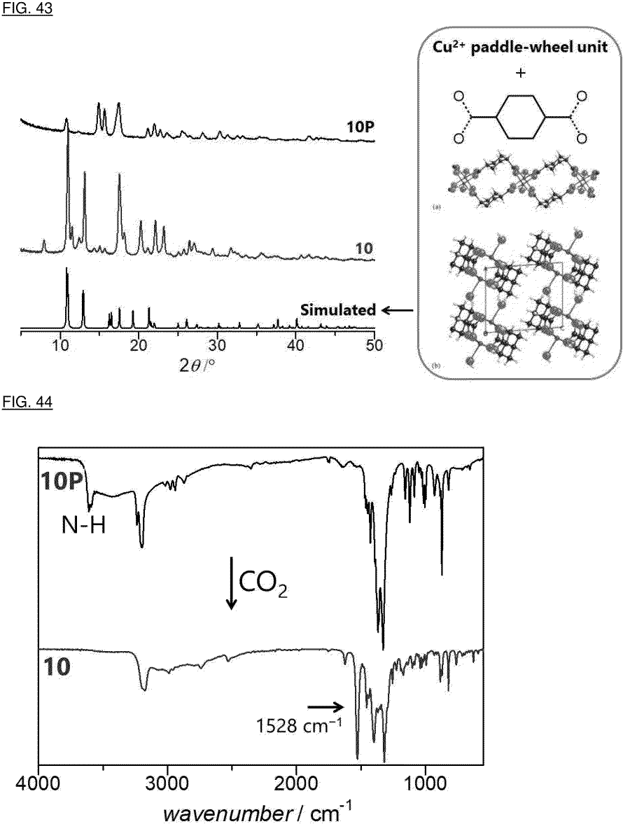

FT-IR measurements of both compounds were performed to trace the change from compound 10P to compound 10. The results are shown in FIG. 44.

FIG. 44 shows the FT-IR spectra of compound 10 and compound 10P. As can be seen in FIG. 44, with the change from compound 10P to compound 10, the peak corresponding to N-H (around 3600 cm⁻¹) disappeared and a new peak corresponding to C═O (around 1528 cm⁻¹) was formed.

From the differences in the PXRD patterns and FT-IR spectra of compound 10 and compound 10P, and from the facts observed during synthesis, the following mechanism can be inferred.

First, in the first step, the Cu salt reacted with H₂PZ to form a mononuclear or macromolecular complex, producing a purple precipitate (compound 10P). This precipitate is considered to have a composition of, for example, [Cu(H₂PZ)ₓ(NO₃)₂], based on the presence of N—H described above.

Next, in the second step, the introduction of a gas containing CO₂ cleaved the Cu—N bond, forming a carbamate anion moiety and a Cu—O bond, producing a blue precipitate (compound 10). This precipitate is considered to have a composition of, for example, [Cu(PDC)], based on the presence of C═O described above.

The color change associated with the conversion from compound 10P to compound 10 suggests a conversion of the electronic structure of Cu²⁺ due to a change in the ligand.

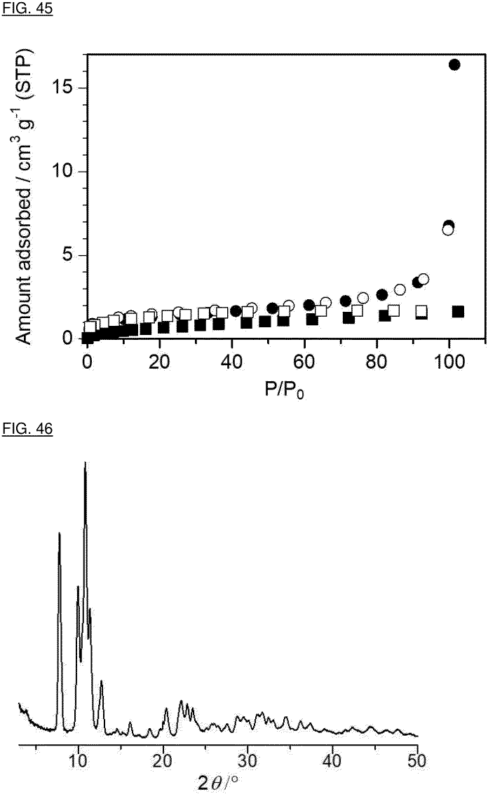

Gas adsorption measurements were performed for compound 10. The results are shown in FIG. 45.

FIG. 45 shows the nitrogen adsorption isotherm at 77 K and the carbon dioxide adsorption isotherm at 195 K for compound 10. In FIG. 45, the amount of nitrogen adsorbed is shown as a circle and the amount of carbon dioxide adsorbed is shown as a square. The BET specific surface area calculated from the former was 4.78 m²/g, and the CO₂ adsorption capacity indicated from the latter was 1.6 cm³/g. That is, compound 10 was not porous.

### Example 11

Powder X-ray diffraction (PXRD) measurements were performed on compound 11. The results are shown in FIG. 46.

FIG. 46 shows the PXRD pattern of compound 11. As can be seen from FIG. 46, compound 11 was highly crystalline. The presence of peaks at low angles suggests the formation of a coordination polymer network.

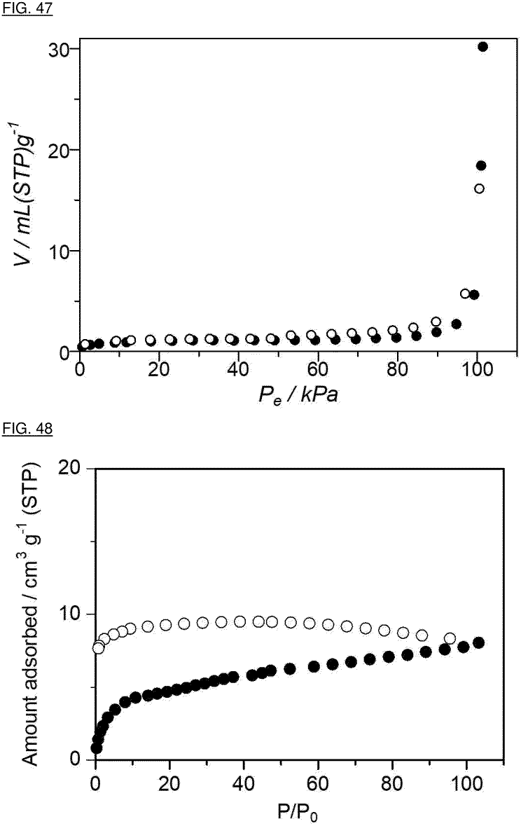

Gas adsorption measurements were performed for compound 11. The results are shown in FIGS. 47 and 48.

FIG. 47 shows the nitrogen adsorption isotherm at 77 K for compound 11. FIG. 48 shows the carbon dioxide adsorption isotherm at 195 K for compound 11. The BET specific surface area calculated from the former was 3.57 m²/g, and the CO₂ adsorption capacity indicated from the latter was 8 cm₃/g. That is, the results shown in FIGS. 47 and 48 indicate that compound 11 is not porous.

TGA measurements were performed on compound 11. The results are shown in FIG. 49.

FIG. 49 shows the TGA-DTA profile of compound 11. As shown in FIG. 49, compound 11 shows no weight loss until around 300° C. after the internal solvent is removed at around 90° C., indicating that it has excellent thermal stability.

### Example 12

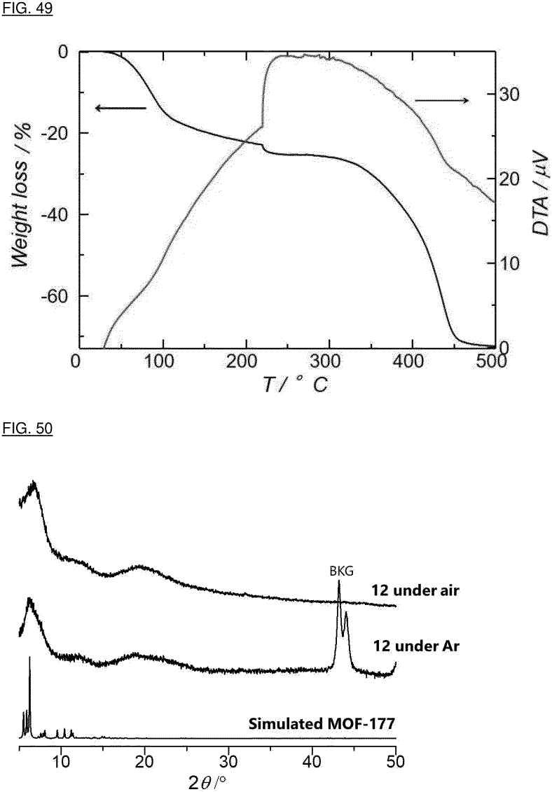

Powder X-ray diffraction (PXRD) measurements were performed on compound 12 both under Ar atmosphere and in air. The results are shown in FIG. 50, along with the simulation pattern of MOF-177.

FIG. 50 shows the PXRD patterns of compound 12 and MOF-177. As can be seen in FIG. 50, although the crystallinity of compound 12 was not very high, the broad peaks at low angles are similar to those of MOF-177, suggesting the presence of a network structure similar to that of MOF-177. Compound 12 was also found to retain its structure in air.

FT-IR measurements were performed on compound 12. The results are shown in FIG. 51, along with the measurement results for compound 1.

FIG. 51 shows the FT-IR spectra of compound 12 and compound 1. As can be seen from FIG. 51, compound 12 had an FT-IR spectrum similar to that of compound 1. That is, compound 12 retains Zn₄O clusters and is suggested to have a carbamate ligand.

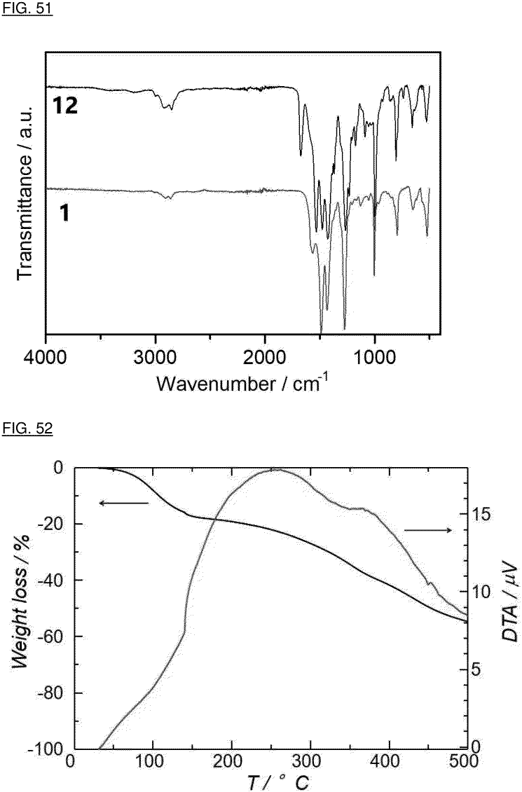

TGA measurements were performed on compound 12. The results are shown in FIG. 52.

FIG. 52 shows the TGA-DTA profile of compound 12. As shown in FIG. 52, compound 12 shows no weight loss until around 250° C. after the internal solvent is removed at around 140° C., indicating that it has excellent thermal stability.

### Example 13

Powder X-ray diffraction (PXRD) measurements were performed on compound 13 both under Ar atmosphere and in air. These results are summarized in FIG. 53.

FIG. 53 shows the PXRD pattern of compound 13. As can be seen from FIG. 53, compound 13 was highly crystalline. The presence of peaks at low angles suggests the formation of a coordination polymer network. Compound 13 was also found to retain its structure in air.

### Example 14

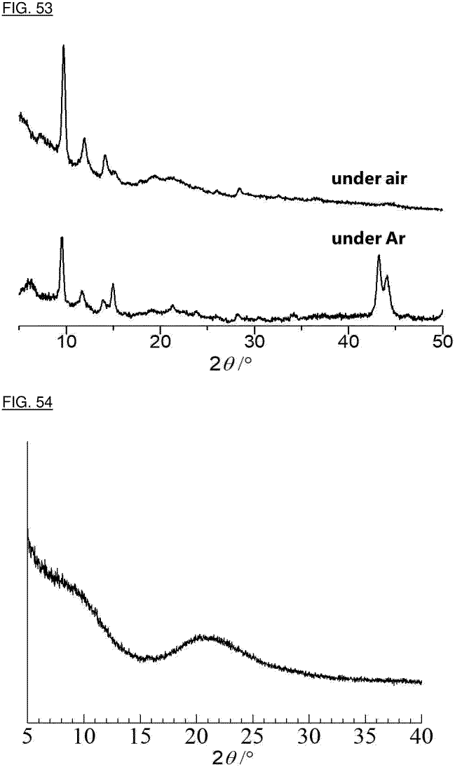

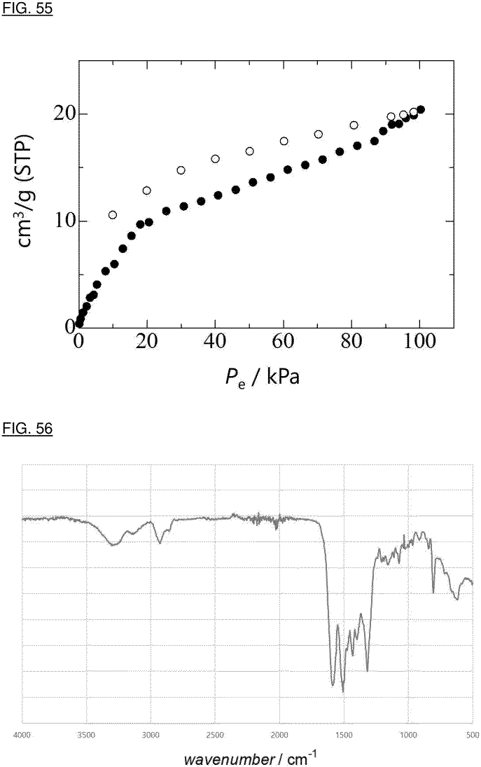

Powder X-ray diffraction (PXRD) measurements were performed on compound 14. These results are summarized in FIG. 54.

FIG. 54 shows the PXRD pattern of compound 14. As can be seen from FIG. 54, compound 14 was amorphous.

Gas adsorption measurements were performed for compound 14. The results are shown in FIG. 55.

FIG. 55 shows the carbon dioxide adsorption isotherm at 195 K for compound 14. The amount of CO₂ adsorbed, as indicated by the results shown in FIG. 55, was 20.5 cm³/g. That is, the results shown in FIG. 55 indicate that compound 14 is porous.

FT-IR measurements were performed on compound 14. The results are shown in FIG. 56.

FIG. 56 shows the FT-IR spectrum of compound 14. As shown in FIG. 56, compound 14 exhibited peaks corresponding to N—H and C═O. The results suggest that compound 14 has the structure represented by NH(CO₂)CH₂CH₂CH₂NH(CO₂).

TGA measurements were performed on compound 14. The results are shown in FIG. 57.

FIG. 57 shows the TGA-DTA profile of compound 14. As shown in FIG. 57, compound 14 does not show a large weight loss until around 120° C., indicating that it has moderate thermal stability.

### Example 15

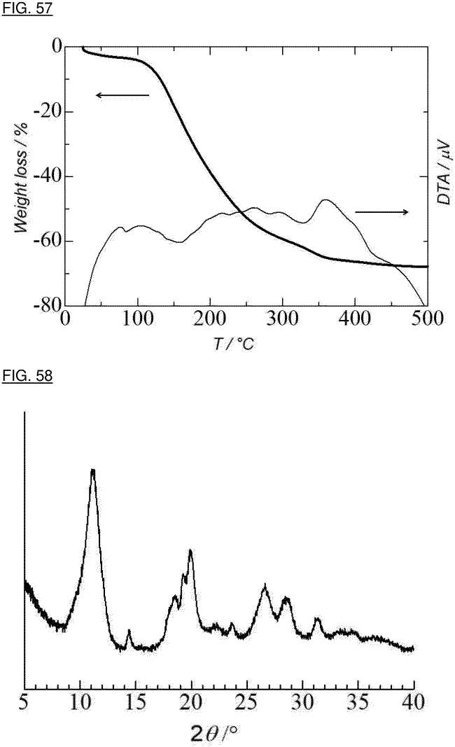

Powder X-ray diffraction (PXRD) measurements were performed on compound 15. These results are summarized in FIG. 58.

FIG. 58 shows the PXRD pattern of compound 15. As can be seen from FIG. 58, compound 15 was highly crystalline. The presence of peaks at low angles suggests the formation of a coordination polymer network.

Gas adsorption measurements were performed for compound 15. The results are shown in FIG. 59.

FIG. 59 shows the carbon dioxide adsorption isotherm at 195 K for compound 15. The amount of CO₂ adsorbed, as indicated by the results shown in FIG. 59, was 9.4 cm³/g.

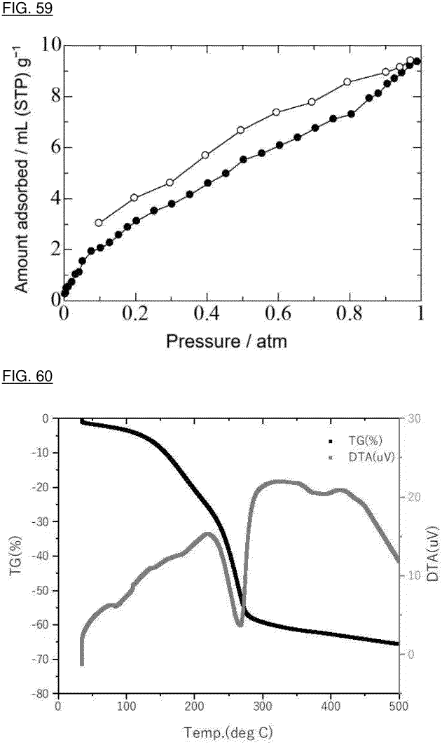

TGA measurements were performed on compound 15. The results are shown in FIG. 60.

FIG. 60 shows the TGA-DTA profile of compound 15. As shown in FIG. 60, compound 15 was found to have moderate thermal stability.

### Example 16

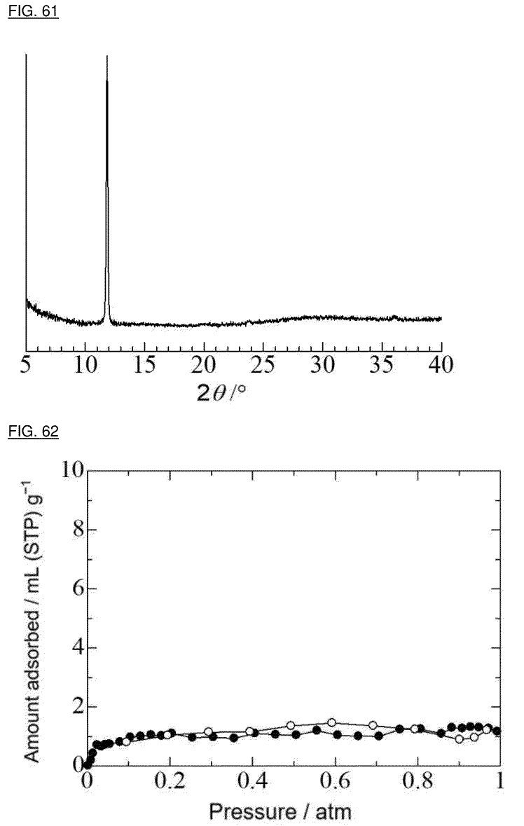

Powder X-ray diffraction (PXRD) measurements were performed on compound 16. These results are summarized in FIG. 61.

FIG. 61 shows the PXRD pattern of compound 16. As can be seen from FIG. 61, compound 16 was highly crystalline. The presence of peaks at low angles suggests the formation of a coordination polymer network.

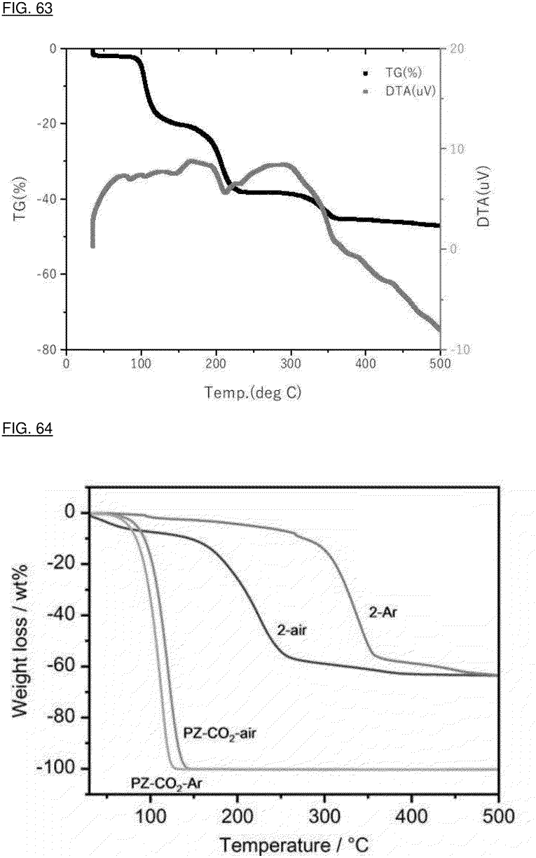

Gas adsorption measurements were performed on compound 16. The results are shown in FIG. 62.

FIG. 62 shows the carbon dioxide adsorption isotherm at 195 K for compound 16. The amount of CO₂ adsorbed, as indicated by the results shown in FIG. 62, was 1.3 cm³/g.

TGA measurements were performed on compound 16. The results are shown in FIG. 63.

FIG. 63 shows the TGA-DTA profile of compound 16. As shown in FIG. 63, compound 16 showed a stepwise weight loss, indicating that it has moderate thermal stability.

Typical information for each of the above examples is summarized in Table 5 below. As shown in Table 5 below, examples 1 through 8 and 10 through 16 were able to fix carbon dioxide. In Examples 1 through 13 and 15 and 16, crystalline coordination polymers were obtained. In particular, coordination polymers with high crystallinity were obtained in Examples 1 through 5, 7, 9 through 11, 13, and 15 and 16. Porous coordination polymers were obtained in Examples 1 through 9 and 14.

TABLE 5

| Example | Metal | Amine | Auxiliary Ligand | CO₂ Fixation | Crystallinity | BET Surface Area (m²g⁻¹) | CO₂ Adsorption Amount (cm³g⁻¹) | Porosity | Corresponding Known MOF |
|---|---|---|---|---|---|---|---|---|---|
| 1 | Zn | H₂PZ | - | Yes | High | 1525 | 353 | Yes | MOF-5 |
| 2 | Zn | H₂SmPZ | - | Yes | High | 2366 | 187 | Yes | MOF-5 |
| 3 | Zn | H₂RmPZ | - | Yes | High | 1943 | 429 | Yes | MOF-5 |
| 4 | Zn | H₂dmPZ | - | Yes | High | 1270 | 296 | Yes | MOF-5 |
| 5 | Cu | H₂PZ | bpy | Yes | High | 18.5 | 8 | Yes | Cu-JAST |
| 6 | Zr | H₂PZ | - | Yes | Middle | 18.6 | - | Yes | UiO-66 |
| 7 | Cu | H₂PZ | dabco | Yes | High | - | 29 | Yes | Cu-JAST |
| 8 | Zn | DP | - | Yes | Middle | - | 52 | Yes | - |
| 9 | Zn | pXDA | - | No | High | 140 | 48 | Yes | - |
| 10 | Cu | H₂PZ | - | Yes | High | 4.78 | 1.6 | No | - |
| 11 | Mg | H₂PZ | - | Yes | High | 3.57 | 8 | No | - |
| 12 | Zn | tpt | - | Yes | Middle | - | - | Unknown | MOF-177 |
| 13 | Cu | tpt | - | Yes | High | - | - | Unknown | - |
| 14 | Zn | pda | - | Yes | Amorphous | - | 20.5 | Yes | - |
| 15 | Zn | eda | - | Yes | High | - | 9.4 | Unknown | - |
| 16 | Mn | HZ | - | Yes | High | - | 1.3 | Unknown | - |

### Stabilization of Carbamate Structure by Coordination to Metal Ions

Lastly, the stabilization of the carbamate anion moiety in the bridging ligand by coordination to the metal ion was investigated by experiment and simulation.

As a control compound, PZ-CO₂ was synthesized. This synthesis was performed according to Ref. 5 below.

Ref. 5: Sim, J. et al. Bull. Korean Chem. Soc. 2016, 37 (11), 1854-1857.

The synthetic scheme for PZ-CO₂ is shown below.

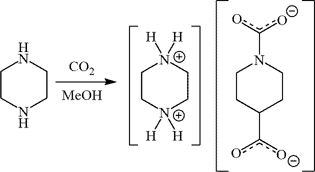

TGA measurements were performed on compound 2 and PZ-CO₂ to demonstrate stabilization of the carbamate structure by coordination to metal ions. The measurements were performed both in air and in an Ar atmosphere. The results are shown in FIG. 64.

FIG. 64 shows the TGA profiles of compound 2 and PZ-CO₂ in air and under Ar atmosphere. As shown in FIG. 64, compound 2 had superior thermal stability compared to PZ-CO₂.

Temperature Programmed Desorption (TPD) measurements of CO₂ were performed for compound 2 and PZ-CO₂. This TPD measurement was performed using MicrotracBEL BELCAT. The temperature range was 30° C. to 500° C. and the heating rate was 10° C./min. The measurements were performed under Ar gas flow (30 mL/min) using 10 mg of each sample. The results are shown in FIG. 65, along with the results of the TGA measurements.

FIG. 65 shows the TGA and TPD profiles of compound 2 and PZ-CO₂ under Ar atmosphere. As shown in FIG. 65, compound 2 has a higher CO₂ release temperature and better thermal stability than PZ-CO₂.

The binding energy between the metal ion and the carbamate anion moiety was then evaluated by theoretical calculation. Specifically, the binding energy between Zn²⁺ and PDC was examined by DFT (Density Functional Theory) calculations. The DFT calculations were performed using the Fritz Haber Institute ab initio molecular simulations (FHI-aims) package version 171221_1.

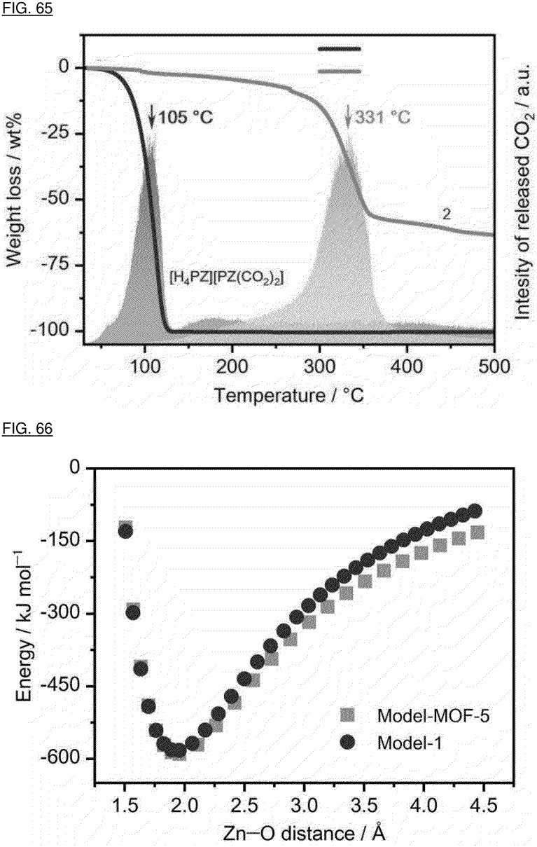

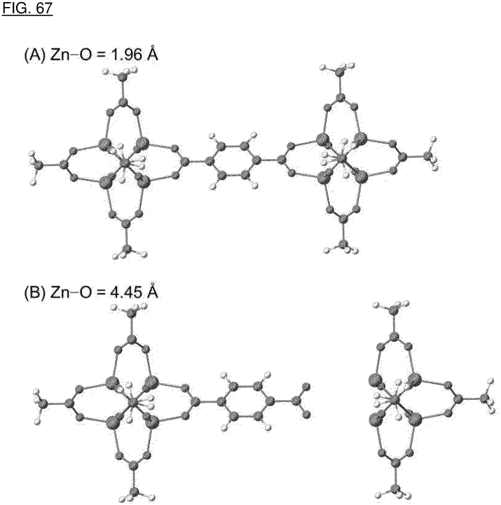

The [Zn₄O(OAc)₅]-PDC-[Zn₄O(OAc)₅] structure, in which two [Zn₄O(CO₂)₆] clusters capped with acetate anions are connected by a single PDC, was used as the model for the calculation corresponding to compound 1. The total energy of the model in question was then calculated by varying the distance between Zn²⁺ and the oxygen atoms of the PDC in the range of 1.51 Å to 4.43 Å. These results are shown in FIGS. 66 and 67.

FIG. 66 shows the potential energy as a function of Zn-O distance in the model structures of compound 1 and MOF-5. FIG. 67 shows the model structure of compound 1 corresponding to the maximum and minimum values of the potential energy. As can be seen from FIGS. 66 and 67, the potential energy reached a minimum when the Zn-O distance was 1.96 Å and a maximum at 4.45 Å. This result indicates that the coordination of the carbamate anion moiety of PDC to Zn decreases the potential energy.

The above TGA and TPD profiles and DFT calculations suggest that the carbamate anion moiety in the bridging ligand is thermodynamically stabilized by coordination to the metal ion in the material and method for carbon dioxide fixation according to the present invention, as well as in the porous coordination polymer and its production method according to the present invention.

1. A material for carbon dioxide fixation, comprising:
a metal ion donor; and
an amine as a precursor of a bridging ligand, wherein:
the amine is configured to react with a gaseous carbon dioxide to form the bridging ligand comprising at least one carbamate anion moiety, and
the bridging ligand is configured to react with the metal ion donor to form a coordination polymer in which a plurality of the metal ions is linked by the bridging ligand.

2. The material according to claim 1, wherein the amine comprises two or more primary or secondary amine groups, and is configured to react with the gaseous carbon dioxide to form the bridging ligand comprising two or more carbamate anion moieties.

3. The material according to claim 1, wherein the amine is represented by the general formula (1A) below, 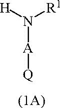
wherein:
R¹ is a hydrogen atom or an alkyl group, or forms a heterocycle with A and a nitrogen atom located between R¹ and A,
A is a single bond or a linker group comprising at least one carbon atom, and
Q is a group configured to form an anion moiety that is able to coordinate to the metal ion.

4. The material according to claim 3, wherein R¹ is a hydrogen atom or forms a heterocycle with A and a nitrogen atom located between R¹ and A, the heterocycle having two or less substituent groups other than Q.

5. The material according to claim 1, wherein the amine is represented by the general formula (2A) below, 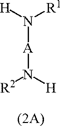
wherein:
R¹ is a hydrogen atom or an alkyl group, or forms a heterocycle with A and a nitrogen atom located between R¹ and A,
A is a single bond or a linker group comprising at least one carbon atom, and
R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.

6. The material according to claim 5, wherein R² is a hydrogen atom, or forms a heterocycle with A and a nitrogen atom located between R² and A, having two or less substituent groups other than a group comprising NHR¹, or forms a heterocycle with a nitrogen atom located between R² and A, A, a nitrogen atom located between R¹ and A, and R¹, having two or less substituent groups.

7. The material according to claim 1, wherein the metal ion donor is configured to donate at least one metal ion selecting from the group consisting of a zinc ion, a copper ion, a zirconium ion, a magnesium ion, an iron ion, a cobalt ion, a chromium ion, and an aluminum ion.

8. The material according to claim 1, wherein a content of carbon dioxide in the coordination polymer is 20% by mass or more.

9. The material according to claim 1, wherein the coordination polymer is a porous coordination polymer with a BET (Brunauer-Emmett-Teller) specific surface area calculated from a nitrogen adsorption isotherm at 77 K being 10 m²/g or more, or with an adsorption amount of carbon dioxide at 195 K and 1 atm being 15 cm³(STP)/g or more.

10. The material according to claim 1, wherein a formation of the coordination polymer is configured to be conducted under an atmospheric pressure and normal temperature condition, or under a condition milder than the atmospheric pressure and normal temperature condition.

11. A method of manufacturing a coordination polymer, comprising the steps of:
preparing a formulation comprising a metal ion donor and an amine configured to react with a gaseous carbon dioxide to form a bridging ligand comprising at least one carbamate anion moiety; and
supplying the formulation with a gas comprising carbon dioxide.

12. A method of manufacturing a coordination polymer, comprising the steps of:
forming a bridging ligand comprising at least one carbamate anion moiety by supplying an amine with a gas comprising carbon dioxide; and
reacting the bridging ligand with a metal ion donor.

13. The method according to claim 11, wherein the coordination polymer is a porous coordination polymer with a BET specific surface area calculated from a nitrogen adsorption isotherm at 77 K being 10 m²/g or more, or with an adsorption amount of carbon dioxide at 195 K and 1 atm being 15 cm³(STP)/g or more.

14. The method according to claim 12, wherein the coordination polymer is a porous coordination polymer with a BET specific surface area calculated from a nitrogen adsorption isotherm at 77 K being 10 m²/g or more, or with an adsorption amount of carbon dioxide at 195 K and 1 atm being 15 cm³(STP)/g or more.

15. The method according to claim 11, wherein the method is conducted under an atmospheric pressure and normal temperature condition, or under a condition milder than the atmospheric pressure and normal temperature condition.

16. The method according to claim 11, wherein the gas comprising carbon dioxide is air.

17. A porous coordination polymer, comprising:
a plurality of metal ions; and
a plurality of bridging ligands, each comprising at least one carbamate anion moiety, wherein:
at least a part of the plurality of metal ions is coordinated by the carbamate anion moiety, thereby forming a porous framework wherein the plurality of metal ions and the plurality of bridging ligands are connected to each other, and
a BET specific surface area calculated from a nitrogen adsorption isotherm at 77 K is 10 m²/g or more, or with an adsorption amount of carbon dioxide at 195 K and 1 atm is 15 cm³(STP)/g or more.

18. The porous coordination polymer according to claim 17, wherein each of the plurality of the bridging ligands has two or more carbamate anion moieties.

19. The porous coordination polymer according to claim 17, wherein each of the plurality of the bridging ligands is represented by the general formula (1B) below, 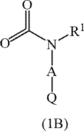
wherein:
R¹ is a hydrogen atom or an alkyl group, or forms a heterocycle with A and a nitrogen atom located between R¹ and A,
A is a single bond or a linker group comprising at least one carbon atom, and
Q⁻ is an anion moiety that is able to coordinate to the metal ion.

20. The porous coordination polymer according to claim 17, wherein each of the plurality of the bridging ligands is represented by the general formula (2B) below, 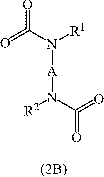
wherein:
R¹ is a hydrogen atom or an alkyl group, or forms a heterocycle with A and a nitrogen atom located between R¹ and A,
A is a single bond or a linker group comprising at least one carbon atom, and
R² is a hydrogen atom or an alkyl group, or forms a heterocycle with A and a nitrogen atom located between R² and A, or forms a heterocycle with a nitrogen atom located between R² and A, A, a nitrogen atom located between R¹ and A, and R¹.
